(19) United States
(12) Patent Application Publication
(10) Pub. No.: US 2025/0145545 A1
(43) Pub. Date: May 8, 2025

(54) PHOSPHOROUS CONTAINING PARTICLES

(71) Applicant: NDSU Research Foundation, Fargo, ND (US)

(72) Inventors: Shirsa Mazumdar, Fargo, ND (US); Achintya Nayan Bezbaruah, Fargo, ND (US); Mohiuddin Quadir, Fargo, ND (US)

(73) Assignee: NDSU Research Foundation, Fargo, ND (US)

(21) Appl. No.: 18/939,747

(22) Filed: Nov. 7, 2024

Related U.S. Application Data
(60) Provisional application No. 63/547,579, filed on Nov. 7, 2023.

(51) Int. Cl. C05G 5/30; C05B 7/00; C05B 13/06; C05B 17/00

(52) U.S. Cl. CPC C05G 5/37; C05B 7/00; C05B 13/06; C05B 17/00

(57) ABSTRACT

A particle that includes a core and one or more layers. The core includes a fertilizer element. The one or more layers may include a polycation polymer and/or a polyanion polymer. Compositions include a plurality of particles and methods of using the particles and compositions containing the same.

### CROSS-REFERENCE TO RELATED APPLICATION

This application claims the benefit of U.S. Provisional Patent Application No. 63/547,579 filed Nov. 7, 2023, which is incorporated herein by reference in its entirety.

### GOVERNMENT FUNDING

This invention was made with government support under grant number 2022-67022-37016 awarded by the United States Department of Agriculture's National Institute for Food and Agriculture (USDA/NIFA). The government has certain rights to this invention.

### SUMMARY

In one aspect, this disclosure describes a particle. The particle includes a core, a first layer. In one or more embodiments the particle includes a second layer. The first layer is disposed on at least a portion of the core. The second layer is disposed on at least a portion of the first layer. In some embodiments, the particle includes a third layer disposed on at least a portion of the second layer. The core includes a fertilizer element. In some embodiments, the fertilizer element is phosphorus. In one or more embodiments, the core includes rock phosphate, hydroxyapatite, or both. One or more layers may include a polycation polymer such as chitosan and/or a polyanion polymer such as poly(citric acid-co-glycerol).

In another aspect, this disclosure describes compositions that include a plurality of the particles described herein.

In yet another aspect, this disclosure describes a method of using the particles and/or compositions described herein.

### BRIEF DESCRIPTION OF FIGURES

FIG. 1 is a schematic of a cross-sectional view of a particle of consistent one or more embodiments of the present disclosure.

FIG. 2 is a second schematic of a cross-sectional view of a particle consistent one or more embodiment of the present disclosure.

FIG. 3 is a third schematic of a cross-sectional view of a particle consistent with one or more embodiments of the present disclosure.

FIG. 4 is a schematic of a process for preparing a coated nano-rock phosphate (NRP) particle by layer-by-layer (LbL) self-assembly of CH and PCA.

FIG. 5 is a schematic of a of a process for preparing a rock phosphate or hydroxyapatite (HAP) core coated with a first layer of chitosan (CH coated RP/HAP) in contact with the core followed by a layer of PCA (called polycitric acid and PCA in the figure) in contact with the chitosan layer.

FIG. 6 shows transmission electron microscopy images of NRP at different magnifications after grinding by a ball mill.

FIG. 7 is a plot showing the particle size distribution of NRP after grinding by a ball mill. The average particles size is 118 plus or minus 33.72 nanometers (nm).

FIG. 8 is the Fourier-transform infrared spectroscopy (FT-IR) spectra of citric acid, glycerol, and poly(citric acid-co-glycerol).

FIG. 9 is the ¹H NMR spectrum of only PCA hyperbranched polyester in D₂O.

FIG. 10 is the ¹³C NMR spectra of only poly(citric acid-co-glycerol) hyperbranched polyester dimethyl sulfoxide.

FIG. 11 is the Fourier-transform infrared spectroscopy (FT-IR) spectra of NRP, CH, an NRP-CH particle, and a NRP-CH-PCA particle.

FIG. 12 shows the zeta potential and hydrodynamic particle distribution by dynamic light scattering technique for NRP.

FIG. 13 illustrates the phosphorus (P) cycle in the soil-plant system and the pathways of P movement.

FIG. 14 is a scanning electron microscopy energy-dispersive X-ray spectroscopy (SEM-EDS) trace of NRP.

FIG. 15 shows a scanning electron microscopy energy-dispersive X-ray spectroscopy (SEM-EDS) trace of NRP coated with CH.

FIG. 16 is a plot showing the zeta potential in millivolt (mV) of particles of NRP; particles of rock phosphate coated with chitosan (CH coated RP); particles of rock phosphate having two coatings, a first layer that includes chitosan (CH) and a second layer that includes poly(citric acid-co-glycerol) (PCA, CH-PCA coated RP); particles of rock phosphate having three coating layers, a first layer that includes CH, a second layer that includes PCA, and a third layer that includes CH (CH-PCA-CH coated RP); and particles of rock phosphate having four coating layers, a first layer that includes CH, a second layer that includes PCA, a third layer that includes CH, and a fourth layer that includes PCA (CH-PCA-CH-PCA coated RP).

FIG. 17 is a schematic representation of the preparation and coating process of NRP for controlled phosphorus release

FIG. 18 is a plot showing the total carbon content for NRP particles, NRP-CH particles, NRP-CH-PCA particles, NRP-CH-PCA-CH particles, and NRP-CH-PCA-CH-PCA particles.

FIG. 19 shows values of the total carbon content for NRP particles, NRP-CH particles, NRP-CH-PCA particles, NRP-CH-PCA-CH particles, and NRP-CH-PCA-CH-PCA particles.

FIG. 20 is a calibration curve used for determining the total carbon content after dissolution at different time intervals.

FIG. 21 is a plot of the total carbon content (in milligrams per liter (mg/L)) for NRP particles, NRP-CH particles, NRP-CH-PCA particles, NRP-CH-PCA-CH particles, and NRP-CH-PCA-CH-PCA particles at two time points (14 days and 28 days).

FIG. 22 shows values of the total carbon content (in milligrams per liter (mg/L)) for NRP particles, NRP-CH particles, NRP-CH-PCA particles, NRP-CH-PCA-CH particles, and NRP-CH-PCA-CH-PCA particles at two time points (14 days and 28 day).

FIG. 23 is a schematic showing the structure of a branched polymer polymerized from citric acid and glycerol (poly(citric acid-co-glycerol)).

FIG. 24 is an image of nano-elemental sulfur.

FIG. 25 is a schematic of a method that can be used to make some particles consistent with embodiments of the present disclosure.

FIG. 26 is a fourth schematic of a cross-sectional view of a particle consistent with one or more embodiments of the present disclosure.

FIG. 27 is a second plot showing the zeta potential in millivolt (mV) of the samples in FIG. 16.

FIG. 28 is an XRD diffractogram of nano-rock phosphate (a is from fluorapatite; b is from quartz (SiO₂)).

FIG. 29 is an XPS survey spectra of for NRP and its subsequent coatings: NRP-CH, NRP-CH-PCA, NRP-CH-PCA-CH, and NRP-CH-PCA-CH-PCA.

FIG. 30 is a high-resolution P2p scan of XPS spectra for the particles in FIG. 30.

FIG. 31 shows the XPS atomic percentage analysis of the various coated NRPs based on the survey spectra in FIG. 30.

FIG. 32 shows SEM images of a nano-rock phosphate core before coating (right) and after coating (left).

FIG. 33 shows SEM images of the surface of uncoated (left) and coated nano-rock phosphate core (right) at higher magnification (×5000).

FIG. 34 is a plot showing the cumulative concentration of phosphate leaching over the course of 120 days from nano-rock phosphate (NRP); particles of nano-rock phosphate coated with chitosan (CH; NRP-CH); particles of rock phosphate having two coatings, a first layer that includes CH and a second layer that includes poly(citric acid-co-glycerol) (PCA; NRP-CH-PCA); particles of rock phosphate having three coating layers, a first layer that includes CH, a second layer that includes PCA, and a third layer that includes CH (NRP-CH-PCA-CH); and particles of rock phosphate having four coating layers, a first layer that includes CH, a second layer that includes PCA, a third layer that includes CH, and a fourth layer that includes PCA (NRP-CH-PCA-CH-PCA).

FIG. 35 shows the coefficients (R²), akaike information criterion (AIC), and root Mean Square Error (RMSE) of the examined models for phosphorus release from various coated nano-rock phosphate particles.

FIG. 36 are plots of the phosphorus release kinetics model fitting curves of various coated nano-rock phosphate particles using Korsmeyer-Peppas model.

FIG. 37 shows the nutrient release rate constant (K), and diffusion exponent (n) according to the Korsmeyer-Peppas model of the coated nano-rock phosphate particles of FIG. 37.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

The term “and/or” means one or all of the listed elements or a combination of any two or more of the listed elements; the terms “comprises,” “comprising,” and variations thereof are to be construed as open ended—i.e., additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

In the description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

The term “polymer” and “polymeric material” include, but are not limited to homopolymers, copolymers, blends of two or more homopolymers, blends of two or more copolymers, blends of one or more homopolymers and one or more copolymers that have any geometric configuration such as a linear configuration, branched configuration, graft configuration, star configuration, isotactic symmetry, syndiotactic symmetry, atactic symmetry, or any combination thereof. Copolymers are polymers polymerized from two or more monomers and include block copolymers, alternating copolymers, periodic copolymers, statistical copolymers, stereoblock copolymers, gradient copolymers, and the like. Polymers are polymerized from one or more monomers. A polymer polymerized from a particular monomer may be described as a “monomer name” polymer or poly (“monomer name”). For example, a polymer polymerized from citric acid or citrate can be described as pol (citric acid) or poly(citrate). A polymer polymerized from two monomers can be described as, for example, “first monomer name”-“second monomer name” polymer or poly (“first monomer” name-co-“second monomer name”). For example, a polymer polymerized from citric acid and glycerol can be described as a citric acid-glycerol polymer or a poly(citric acid-co-glycerol).

As used herein, the terms “formed from” and “polymerized from” are open ended and may include other components that may not be expressly described relative to the subject that is formed from or polymerized from the stated components. For example, a polymer formed from or polymerized from one or more monomers may include capping groups or other groups not expressly mentioned.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound. The term “essentially free” of a particular compound means that the compositions of the present invention contain less than 100 parts per million (ppm) of the recited compound. The term “completely free” of a particular compound means that the compositions of the present invention contain less than 20 parts per billion (ppb) of the recited compound. In the context of the aforementioned phrases, the compositions of the present invention contain less than the aforementioned amount of the compound whether the compound itself is present in unreacted form or has been reacted with one or more other materials.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used herein, “have,” “has,” “having,” “include,” “includes,” “including,” “comprise,” “comprises,” “comprising” or the like are used in their open-ended inclusive sense, and generally mean “include, but not limited to,” “includes, but not limited to,” or “including, but not limited to.” Further, wherever embodiments are described herein with the language “have,” “has,” “having,” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

For any method disclosed herein that includes discrete steps, the steps may be performed in any feasible order. And, as appropriate, any combination of two or more steps may be performed simultaneously.

As used herein, the word “exemplary” means to serve as an illustrative example and should not be construed as preferred or advantageous over other embodiments.

As used herein, the terms “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the invention.

Throughout the disclosure, RP is rock phosphate; NRP is nano-rock phosphate; CH is chitosan; and PCA is hyperbranched poly(citric acid-co-glycerol), a hyperbranched polyester formed from citric acid and glycerol building blocks.

### DETAILED DESCRIPTION

The current global population exceeds 7.6 billion and is projected to reach 9.5-10 billion in ˜2050. As such, global food production may need to be increased to meet the challenge of feeding nearly 10 billion people. Mineral fertilizers are among the most useful inputs available to farmers for the intensive crop production required to achieve this goal. In this regard, appropriate use of suitable fertilizer may impact the ability to restore and/or maintain fertile soils capable of supporting intensive agriculture, while also protecting the land, air, and water, as well as sustaining biodiversity. In addition to replenishing soil nutrients and increasing crop yields, fertilizer use increases vegetative biomass production. This additional biomass supplements the supply and maintenance of soil organic matter, and thus, positively affects soil properties related to soil health. Fertilizer use can lead to higher crop biomass yields and more carbon dioxide sequestration by plants. However, despite their important roles in crop production, current fertilizers may have low nutrient use efficiency by crops. Nutrient use inefficiency can lead to undesirable environmental consequences, including greenhouse gas production (for example, through nitrogen transformation); impairment of surface (for example, eutrophication); and/or changes in ground water quality.

Phosphorus (P), nitrogen (N), and potassium (K) are important nutrients for crop production. The use of phosphorus by crops may be characterized by low efficiency. For example, over 70% of applied phosphorous is lost, for example, due to fixation in soil or run-off into surface or underground waters. It is thought that phosphorus loss from farm fields happens via three major processes (i) attached to the eroding sediments; (ii) in the surface water run-off (as dissolved phosphorus); and/or (iii) in leachate (as dissolved phosphorus). A total of 360,000 tons of phosphorus is lost from the US crop lands every year which is approximately 16% of a total 2.2 million tons phosphorus fertilizers applied. The average phosphorus loss from the US crop land is approximately 2.4 pounds/acre/year. Of these losses, 63% of the loss is attached to waterborne sediments and approximately 20% of the loss is as dissolved phosphorous in surface run-off. The loss of phosphorus fertilizers may be a concern as it contributes to eutrophication and associated algal blooms and have exacerbates the problem with the dead zones like in the Gulf of Mexico and the Baltic Sea.

Improving existing phosphorus fertilizer products can reduce their potential undesirable environmental consequences. However, some current fertilizer management practices, such as using the right rates and delivery methods (for example, subsurface soil application, foliar application), are limited in their ability to mitigate some of the environmental problems associated with phosphorus fertilizers. An improved phosphorus fertilizer may be able to reduce runoff from the fields and/or supply phosphorous at least during early stages of plant growth when a plant's ability to mineralize soil-bound phosphorus is limited due to less lateral roots and overall low root density.

Increasing plant phosphorus use efficiency may be important, given that phosphorus is a non-renewable mined resource. The supply of good quality mineable rock phosphate (mineral phosphorous) is predicted to last for only 30-240 more years if the current consumption rate continues. It is predicted that phosphate supply will potentially fall short of demand by the year 2033.

To add to the supply and demand problem, the phosphorus use efficiency for US agriculture is only approximately 20% to 25%. Raw rock phosphate is typically not used directly as a fertilizer due to its low solubility and high content of toxic impurities such as cadmium and uranium. However, when processed into water soluble fertilizer, a portion of the soluble phosphorus can be permanently bound to compounds in soil and become unavailable for plant uptake. A second portion can be leached or washed away as run-off from the fields to surface waters. Excess phosphorus in surface waters leads to the devastating eutrophication problems experienced in many places around the world, including the United States.

It is recognized that there is a need to achieve phosphorus sustainability given the limited phosphorus resources left in the world, coupled with low phosphorus use efficiency of plants and increasing severity of surface water impairment.

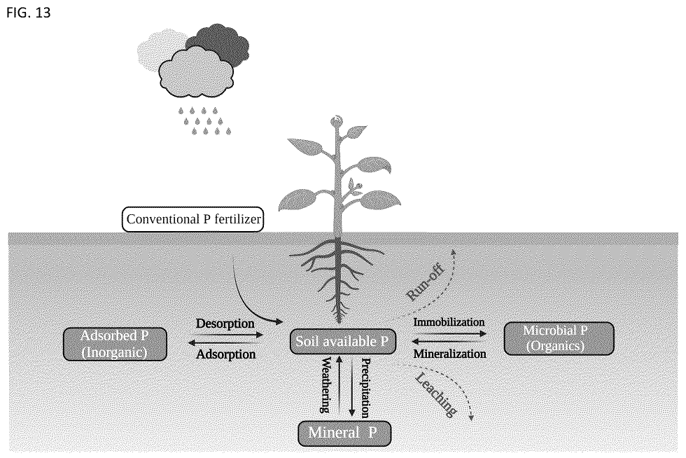

FIG. 13 illustrates the phosphorus (“P” in FIG. 13) cycle in the soil-plant system and the pathways of phosphorus movement. The central section highlights soil-available phosphorus, which is influenced by various processes including adsorption and desorption interactions with inorganic phosphorus, and mineralization and immobilization exchanges with microbial organic phosphorus. Mineral phosphorus is added to the soil through processes like weathering and precipitation. Conventional phosphorus fertilizer application contributes to soil-available phosphorus but can also lead to phosphorus loss through runoff and leaching, depicted by the dashed arrows. These processes indicate potential environmental impacts and nutrient inefficiencies. The overall cycle emphasizes the complexity of phosphorus dynamics in agricultural soils.

The present disclosure describes particles, compositions including the particles, kits including the particles, and methods of using the particles. The particles can be used as a fertilizer. The particles can be included in a fertilizer composition.

A fertilizer is a material that supplies one or more elements (nutrients) useful for plant growth. Common elements supplied by fertilizers include phosphorus (P), nitrogen (N), and potassium (K). Fertilizers can be classified based on what nutrient they include. The elements may be provided in the form of a compound such as a salt. For example, a fertilizer supplying nitrogen can include ammonium nitrate, ammonia, urea, calcium ammonium nitrate, and the like. A fertilizer supplying phosphorous can include, for example, phosphate or a salt thereof. For example, a fertilizer supplying phosphorous may include fluorapatite (Ca₅(PO₄)₃F). A fertilizer supplying potassium can include, for example, potassium chloride. Once supplied to the target, the compound or salt may react and/or dissolve to provide the element in a different form. Fertilizers can be classified based on what nutrient they include. For example, a phosphorous or phosphoric fertilizer is a fertilizer that supplies phosphorous in any form. A nitrogen or nitrogenous fertilizer is a fertilizer that supplies nitrogen in any form. A potassium fertilizer is a fertilizer that supplies potassium in any form. Fertilizers may supply more than one element. For example, a fertilizer may be a phosphorous and nitrogen fertilizer.

In one or more embodiments, the particle is or can be used as a phosphorus fertilizer. In one or more embodiments, the particle is or can be used as a nitrogen fertilizer. In one or more embodiments, the particle is or can be used as a potassium fertilizer. In one or more embodiments, the particle is or can be used as a phosphorus and nitrogen fertilizer.

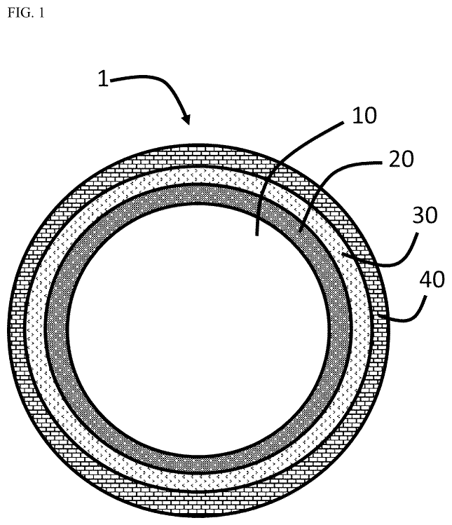

In one aspect, the present disclosure describes a particle. A cross-sectional image of a particle 1 is shown in FIG. 1. The particle 1 includes a core 10 and one or more layers 20, 30, and 40. The one or more layers are disposed on at least a portion of the core or on at least a portion of another layer. The particle may have a core and shell configuration where each layer forms a shell surrounding the core or the layer on which it is disposed. Each layer may include a different material. The location of each layer is described relative to the core. For example, a first layer is disposed on the core, a second layer is disposed on the first layer, a third layer is disposed on the second layer and so forth.

As used herein, the term “disposed on” refers to material that is placed on top of another material such that the two materials are in contact and share an interface. Though FIG. 1 depicts the interface between the core and a layer or two layers as being a rigid boundary, it is understood that at the interface the materials may bleed into each other.

As used herein, the term “layer” refers to a continuous or discontinuous material disposed on the core or another layer. A layer may be disposed on the entirety of the core or another layer, on one portion of the core or another layer, or on multiple discontinuous portions of the core or another layer. The amounts or concentrations of a particular component in a layer may be the same or vary across the layer. The thickness of a layer may be consistent across the entire layer or vary in one or more places across the entire layer.

The particles of the present disclosure may be porous. The particles of the disclosure may be nonporous. One or more layers and/or the core of the particle may be porous. One or more layers and/or the core of the particle may be nonporous.

Though FIG. 1 depicts the cross-section of particle 1 as a neatly defined circle, it is understood that the particles of the present disclosure may be of a variety of shapes and/or amorphous.

The particle 1 includes a core 10. The core may include any suitable material. In one or more embodiments, the core includes one or more fertilizer elements. A fertilizer element can be phosphorous, nitrogen, or potassium, or compounds or salts containing the same. Examples of fertilizer elements include, but are not limited to, ammonia; nitrates such as ammonium nitrate, sodium nitrate, calcium ammonium nitrate, and the like; urea; phosphates such as fluorapatite (Ca₅(PO₄)₃F), hydroxyapatite (Ca₅(PO₄)₃OH or Ca₁₀(PO₄)₆(OH)), calcium phosphate, sodium phosphate, potassium phosphate and the like; phosphorous oxides such as phosphate, phosphorus pentoxide, phosphorus trioxide, phosphorus tetroxide, and salts thereof; monoammonium phosphate; diammonium phosphate; and the like; or any combination thereof.

In one or more embodiments, the core includes phosphorus. In some such embodiments, the core includes phosphate or salt thereof, an phosphorus oxide or a salt thereof, or both. In one or more embodiments, the core includes phosphorus pentoxide (P₂O₅). In one or more embodiments, the core includes fluorapatite (Ca₅(PO₄)₃F). In one or more embodiments, the core includes phosphorus pentoxide, fluorapatite, hydroxyapatite, rock phosphate, or any combination thereof.

In one or more embodiments, the core includes hydroxyapatite (Ca₅(PO₄)₃OH or Ca₁₀(PO₄)₆(OH)). In some such embodiments, the core includes synthetic hydroxyapatite. Synthetic hydroxyapatite can be made, for example, by reacting calcium hydroxide (Ca(OH)₂) with phosphoric acid (H₃PO₄). In one or more embodiments, the core includes 50 wt-% or greater hydroxyapatite, 70 wt-% or greater hydroxyapatite, 70 wt-% or greater hydroxyapatite, 80 wt-% or greater hydroxyapatite, 90 wt-% or greater hydroxyapatite, or 95 wt-% or greater hydroxyapatite. In one or more embodiments, the only fertilizer element in the core is hydroxyapatite.

In one or more embodiments, the core includes rock phosphorus. Rock phosphorous (also called phosphorite or phosphate rock) is a non-detrital sedimentary rock that includes a high amount of phosphate minerals. Examples of phosphate minerals that can be included rock phosphate include phosphorus pentoxide (P₂O₅), fluorapatite Ca₅(PO₄)₃F, hydroxyapatite Ca₅(PO₄)₃OH or Ca₁₀(PO₄)₆(OH)₂, chlorapatite (Ca₅(PO₄)₃Cl) or any combination thereof. Rock phosphorus can include other materials in addition to phosphate minerals. For example, rock phosphorous can include SiO₂.

Rock phosphorous can include, for example, 5 wt-% or mol-% or greater, 10 wt-% or mole-% or greater, 20 wt-% or mol-% or greater, 30 wt-% or mol-% or greater, 40 wt-% or mol-% or greater, 50 wt-% or mol-% or greater, 60 wt-% or mol-% or greater, 70 wt-% or mol-% or greater, 80 wt-% or mol-% or greater, or 90 wt-% or mol-% or greater phosphate minerals.

In one or more embodiments, the core includes 50 wt-% or greater rock phosphorus, 60-wt-% or greater rock phosphorus, 70 wt-% or greater rock phosphorus, 70 wt-% or greater rock phosphorus, 80 wt-% or greater rock phosphorus, 90 wt-% or greater rock phosphorus, or 95 wt-% or greater rock phosphorus. In one or more embodiments, the core is 100% rock phosphorus.

Rock phosphorous can include, for example, 5 wt-% or mol-% or greater, 10 wt-% or mole-% or greater, 20 wt-% or mol-% or greater, 30 wt-% or mol-% or greater, 40 wt-% or mol-% or greater, 50 wt-% or mol-% or greater, 60 wt-% or mol-% or greater, 70 wt-% or mol-% or greater, 80 wt-% or mol-% or greater, or 90 wt-% or mol-% or greater phosphorus pentoxide (P₂O₅). In one or more embodiments, the core includes 50 wt-% or greater, 60-wt-% or greater, 70 wt-% or greater, 70 wt-% or greater, 80 wt-% or greater, 90 wt-% or greater, or 95 wt-% or greater phosphorus pentoxide (P₂O₅).

The core can include various amounts of phosphorus. The amount of phosphorous can be measured, for example, as an atom-% using X-ray photoelectron spectroscopy. In one or more embodiments, the core includes 0.01 atom-% or greater phosphorous, 0.1 atom-% or greater phosphorous, 0.5 atom-% or great phosphorous, 1 atom-% or greater phosphorous, 1.2 atom-% or greater phosphorous, 1.4 atom-% or greater phosphorous, 1.6 atom-% or greater, phosphorous, 1.8 atom-% or greater, phosphorus, 2 atom-% or greater phosphorus, 2.5 atom-% or greater phosphorus, 3 atom-% or greater phosphorus, 3.5 atom-% or greater, phosphorous, 4 atom-% or greater phosphorus, 4.5 atom-% or greater phosphorus, 5 atom-% or greater phosphorus, 6 atom-% or greater phosphorous, 7 atom-% or greater phosphorous, 8 atom-% or greater phosphorous, 9 atom-% or greater phosphorous, 10 atom-% or greater phosphorous, 11 atom-% or greater phosphorous, 12 atom-% or greater phosphorous, 13 atom-% or greater phosphorous, 14 atom-% or greater phosphorous, 15 atom-% or greater phosphorous, 20 atom-% or greater phosphorous, 25 atom-% or greater phosphorous, 30 atom-% or greater phosphorous, 35 atom-% or greater phosphorous, 45 atom-% or greater phosphorous, or 50 atom-% or greater phosphorous.

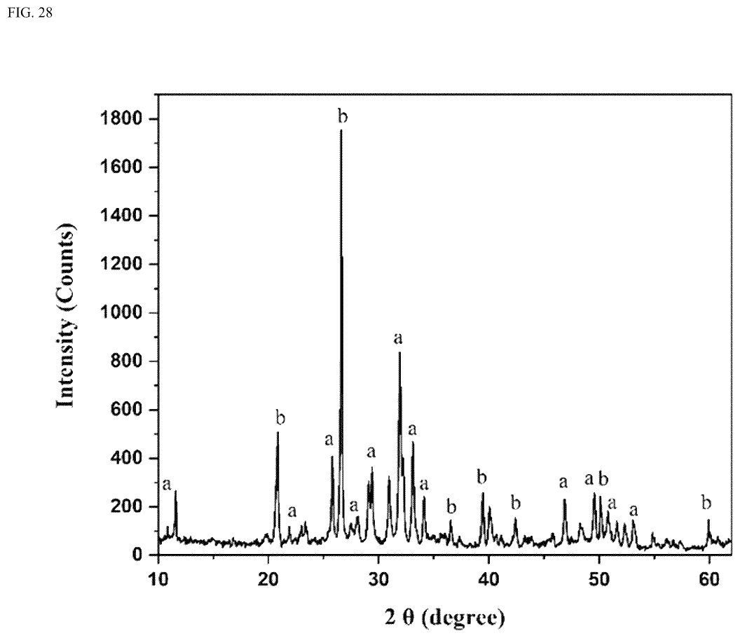

FIG. 28 is an X-ray diffraction (XRD) diffractogram of a nano-rock phosphate sample. Fluorapatite (Ca₅(PO₄)₃F), and quartz (SiO₂) were identified as large components in the sample (peaks labeled with “a” correspond to fluorapatite and peaks labeled with “b” correspond to quartz).

The size of the core can impact the size of the particle. The term “size” refers to the largest dimension of the material being measured (e.g., particle or core). The size may be determined by using microscopy such as optical microscopy, scanning electron microscopy or transmission electron microscopy. A plurality of material (e.g., a plurality of cores or a plurality of particles), can have an average size. The average size can be the number average size of the plurality of particles.

In one or more embodiments, the core or plurality of cores has a size or an average size of 50 nanometers (nm) or greater, 100 nm or greater, 200 nm or greater, 300 nm or greater, 400 nm or greater, 500 nm or greater, 600 nm or greater, 700 nm or greater, 800 nm or greater, 900 nm or greater, 1000 nm or greater, 1200 nm or greater, 1400 nm or greater, 1600 nm or greater, 1800 nm or greater, 2000 nm or greater, 2200 nm or greater, 2400 nm or greater, 2600 nm or greater, 2800 nm or greater, 3000 nm or greater, 3200 nm or greater, 3400 nm or greater, 3600 nm or greater, 3800 nm or greater, 4000 nm or greater, or 4500 nm or greater. In one or more embodiments, the core or plurality of cores has a size or an average size of 5000 nm or less, 4500 nm or less, 4000 nm or less, 3800 nm or less, 3600 nm or less, 3400 nm or less, 3200 nm or less, 3000 nm or less, 2800 nm or less, 2600 nm or less, 2400 nm or less, 2200 nm or less, 2000 nm or less, 1800 nm or less, 1600 nm or less, 1400 nm or less, 1200 nm or less, 1000 nm or less, 800 nm or less, 600 nm or less, 400 nm or less, 200 nm or less, or 100 nm or less.

In one or more embodiments, the core or plurality of cores has a size or an average size of 50 nm to 500 nm, such as 50 nm to 300 nm or 100 nm to 300 nm. In one or more embodiments, the core or plurality of cores has a size or average size of 800 nm to 5000 nm such as 1000 nm to 3000 nm or 1000 nm to 2000 nm.

In one or more embodiments, the core is a nano-core (for example nano-rock phosphate or nano-hydroxyapatite). A nano-core or plurality of nano-cores has a size or average size of 10 nm to 500 nm, such as 50 nm to 200 nm, 10 nm to 200 nm, 10 nm to 300 nm, 10 nm to 400 nm, 50 nm to 300 nm, or 50 nm to 400 nm.

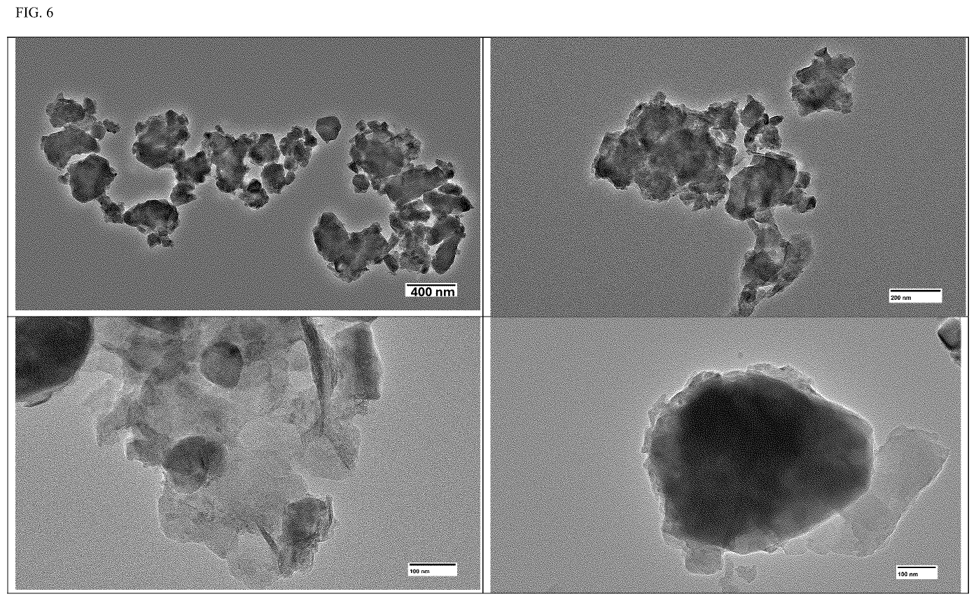

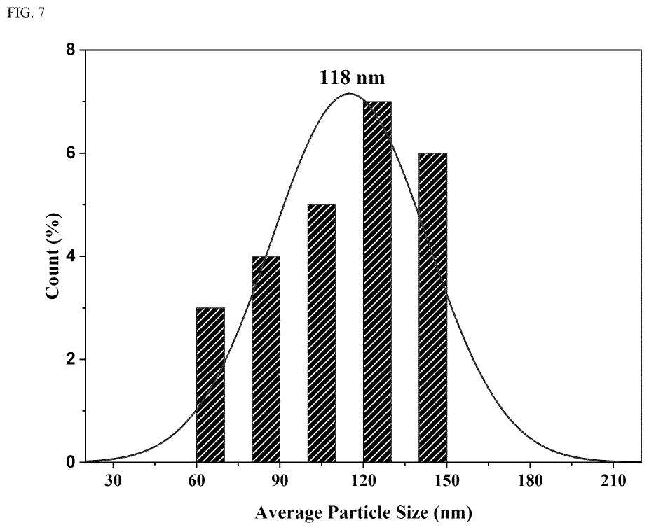

FIGS. 6 and 7 show several transmission electron micrographs (FIG. 6) and core size distribution (FIG. 7) of nano-rock phosphate after grinding bulk rock phosphate with a high energy ball mill. Grinding bulk rock phosphate is able to produce nano-rock phosphate having an average size of 118.88 plus or minus 33.72 nm. The average core size may be controlled by sieving core particles and using sedimentation by centrifugation with an appropriate solvent. Modifying ball mill parameters such as the milling time, milling speed, ball to material ratio can impact the size of the nanoparticles produced.

Referring to FIG. 1, the particle includes one or more layers. In one or more embodiments, the particle includes 1 layer, 2 layers, 3 layers, 4 layers, 5 layers, 6 layers, 7 layers, 8 layers, 9 layers, or 10 layers. For example, a particle may include a first layer disposed on at least a portion of the core, a second layer disposed on at least a portion of the first layer, and a third layer disposed on at least a portion of the second layer. A particle may include a first layer disposed on at least a portion of the core, a second layer disposed on at least a portion of the first layer, a third layer disposed on at least a portion of the second layer, and fourth layer disposed on at least a portion of the third layer. The material of each layer may vary. The particle may include one or more layers of the same material.

Irrespective of the number of layers, a particle includes an outermost layer (40 in FIG. 1). The outermost layer is the last layer applied to the particle. In one or more embodiments, the outermost layer is the layer that is exposed to the surrounding environment. It is understood that other layers may also be exposed to the surrounding environment when the outmost layer or other layers more interior than the outermost layer are discontinuous. For example, the layer directly below the outmost layer may be exposed to the surrounding environment if the outmost layer is discontinuous. The particle may have 1 layer, 2 layers, 3 layers, 4 layers, 5 layers, 6 layers, 7 layers, 8 layers, or 9 layers, in addition to the outermost layer.

In one or more embodiments, the outermost layer (40 in FIG. 1) of the particle includes sulfur. In one or more embodiments, the sulfur may be elemental sulfur. In one or more embodiments, the sulfur may be in the form of a compound and/or a salt. In one or more embodiments, the outermost layer includes sulfate, thiosulfate, or a salt thereof such as a sodium salt thereof (e.g., sodium sulfate and sodium thiosulfate). In one or more embodiments, the outermost layer includes nano-elemental sulfur (nanoS). A nanoS particle of a plurality of nanoS particles has a size or an average size of 1 nm to 500 nm, such as 10 nm to 200 nm. Nano-elemental sulfur can be made, for example, by grinding and/or milling bulk elemental sulfur.

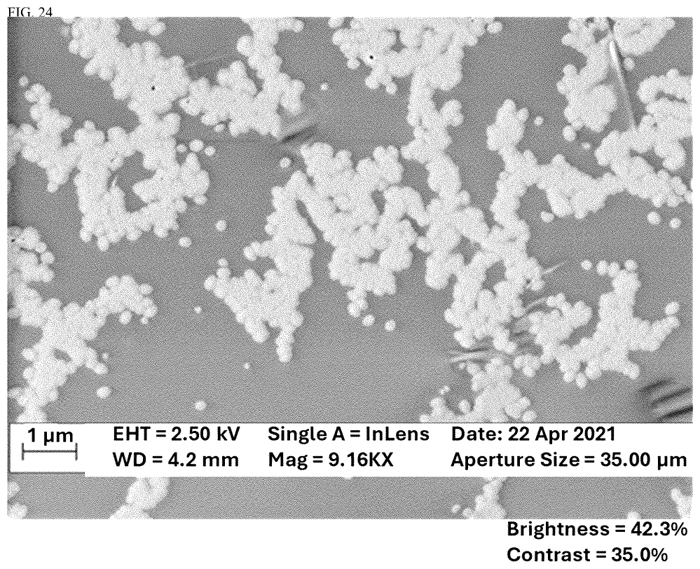

NanoS may be synthesized, for example, by a thiosulfate disproportionation reaction. For example, nanoS may be synthesized by adding sodium thiosulfate to citric acid in a solution containing a cationic surfactant stabilizer such as didecyldimethylammonium (DDAC). FIG. 24 shows an image of nanoS made using this method.

NanoS may be synthesized via disproportionation reaction of thiosulfate in the presence of a chitosan-citric acid (CH-CA) gel matrix. For example, a thiosulfate aqueous solution (e.g., 2.0 molar thiosulfate) can be added dropwise to CH-CA gel matrix (e.g., a 1% CH agriculture-grade low molecular weight CH-CA gel; pH 2-3). The amount of sulfur loading the CH-CA gel may be in the range of 0.25 wt-% to 2.0 wt-%. It is thought that pH, thiosulfate concentration, and/or the gel viscosity will have an effect on the nanoS particle size and size distribution. Small-sized nanoS with narrow size distribution may be desirable for use in coatings. The synthesized nanoS can be separated from the gel by dilution followed by ultra-centrifugation.

The average size, size distribution, and shape of the nanoS can be evaluated using electron microscopy and/or dynamic light scattering (DLS). X-ray crystallography can be used to characterize nanoS crystallinity.

The inclusion of sulfur in the outermost layer may enhance the mechanical properties of the particle. For example, sulfur (such as elemental sulfur) may facilitate abrasion resistance. The inclusion of sulfur in the outermost layer may reduce the hydrophilicity of the exterior surface of the particle which may improve water vapor barrier properties. Additionally, sulfur is a nutrient that may help plant health and yield. As such, inclusion of sulfur in the outermost layer may allow for the delivery of sulfur to plants.

In one or more embodiments, the outermost layer includes 0.01 wt-% sulfur or greater, 0.1 wt-% sulfur or greater, 1 wt-% sulfur or greater, 5 wt-% sulfur or greater, 10 wt-% sulfur or greater, 20 wt-% sulfur or greater, 30 wt-% sulfur or greater, 40 wt-% sulfur or greater, 50 wt-% sulfur or greater, 60 wt-% sulfur or greater, 70 wt-% sulfur or greater, 80 wt-% sulfur or greater, or 90 wt-% sulfur or greater. In one or more embodiments, the outermost layer includes 99 wt-% sulfur or less, 90 wt-% sulfur or less, 80 wt-% sulfur or less, 70 wt-% sulfur or less, 60 wt-% sulfur or less, 50 wt-% sulfur or less, 40 wt-% sulfur or less, 30 wt-% sulfur or less, 20 wt-% sulfur or less, 10 wt-% sulfur or less, 5 wt-% sulfur or less, 1 wt-% sulfur or less, or 0.1 wt-% sulfur or less. In one or more embodiments, the outermost layer includes 0.01 wt-% to 5 wt-% sulfur or 0.1 wt-% to 5 wt-%.

In one or more embodiments, the outermost layer includes carbon, such as a carbon-based material or a material that includes carbon. In one or more embodiments, the carbon is included in biochar. Biochar is solid pyrolysis product of pyrolyzing biomass. In one or more embodiments, the biochar is corn biochar. In one or more embodiments, the outermost layer includes nano-biochar (nanoBC). A nano-particle or a plurality of nano-biochar particles can have a size or an average size of 1 nm to 500 nm such as 10 nm to 200 nm, 10 nm to 500 nm, 50 nm to 200 nm, 10 nm to 200 nm, 10 nm to 300 nm, 10 nm to 400 nm, 50 nm to 300 nm, 1 nm to 100 nm, 1 nm to 50 nm, or 50 nm to 400 nm. Nano-biochar can be made, for example, by grinding and/or milling bulk biochar.

Biochar can adsorb and desorb phosphate. Further, biochar can improve soil health with increases in water-holding capacity, can increase soil porosity, can increase pH, can create favorable conditions for soil microorganisms, or any combination thereof. The use of agricultural residue-based biochar may also add value to the crop and improve farm productivity. Furthermore, biochar may improve the toughness and/or durability of other layers such as layers that include polymers.

In one or more embodiments, the outermost layer includes 0.01 wt-% biochar or greater, 0.1 wt-% biochar or greater, 1 wt-% biochar or greater, 5 wt-% biochar or greater, 10 wt-% biochar or greater, 20 wt-% biochar or greater, 30 wt-% biochar or greater, 40 wt-% biochar or greater, 50 wt-% biochar or greater, 60 wt-% biochar or greater, 70 wt-% biochar or greater, 80 wt-% biochar or greater, or 90 wt-% biochar or greater. In one or more embodiments, the outermost layer includes 99 wt-% biochar or less, 90 wt-% biochar or less, 80 wt-% biochar or less, 70 wt-% biochar or less, 60 wt-% biochar or less, 50 wt-% biochar or less, 40 wt-% biochar or less, 30 wt-% biochar or less, 20 wt-% biochar or less, 10 wt-% biochar or less, 5 wt-% biochar or less, 1 wt-% biochar or less, or 0.1 wt-% biochar or less. In one or more embodiments, the outermost layer includes 10 wt-% or greater or 20 wt-% or greater biochar.

In one or more embodiments, the outermost layer includes a compound that includes two fertilizer elements. For example, the outermost layer can include a compound that includes phosphorous and nitrogen, nitrogen and potassium, or phosphorous and potassium. In one or more embodiments, the outermost layer includes diammonium phosphate (DAP), monoammonium phosphate (MAP), or both. In one or more embodiments where the outermost layer includes biochar, DAP and/or MAP may be adsorbed onto the biochar. For example, the biochar may act as a carrier for DAP and/or MAP. Biochar having adsorbed DAP and/or MAP may also be referred to as DAP and/or MAP impregnated biochar. DAP and/or MAP impregnated biochar can release phosphate (de-adsorb) in the presence of water. The inclusion of DAP and/or MAP impregnated biochar in the outermost layer may provide a source of accessible phosphate for early growth stage plants.

DAP impregnated nanoBC may be synthesized, for example, by soaking the desired amount of nanoBC in a solution (e.g., 100 mg/L DAP) for an amount of time (e.g., 24 hours). The amount of phosphorus adsorbed onto nanoBC can be calculated (mass balance) based on the initial and final bulk phosphorus concentration (initial and final DAP solution concentrations). The amount of released phosphorus from the nanoBC can be measured, for example, using colorimetry (molybdenum blue and/or malachite green). Phosphorous impregnated nanoBC can also be characterized using electron microscopy. Complete elemental analysis can be done using, for example, inductively coupled plasma optical emission spectroscopy (ICP-OES) or scanning electron microscopy energy dispersive x-ray spectroscopy. The total organic carbon content can be measured.

In one or more embodiments, the outermost layer includes 0.01 wt-% DAP and/or MAP or greater, 0.1 wt-% DAP and/or MAP or greater, 1 wt-% DAP and/or MAP or greater, 5 wt-% DAP and/or MAP or greater, 10 wt-% DAP and/or MAP or greater, 20 wt-% DAP and/or MAP or greater, 30 wt-% DAP and/or MAP or greater, 40 wt-% DAP and/or MAP or greater, 50 wt-% DAP and/or MAP or greater, 60 wt-% DAP and/or MAP or greater, 70 wt-% DAP and/or MAP or greater, 80 wt-% DAP and/or MAP or greater, or 90 wt-% DAP and/or MAP or greater. In one or more embodiments, the outermost layer includes 99 wt-% DAP and/or MAP or less, 90 wt-% DAP and/or MAP or less, 80 wt-% DAP and/or MAP or less, 70 wt-% DAP and/or MAP or less, 60 wt-% DAP and/or MAP or less, 50 wt-% DAP and/or MAP or less, 40 wt-% DAP and/or MAP or less, 30 wt-% DAP and/or MAP or less, 20 wt-% DAP and/or MAP or less, 10 wt-% DAP and/or MAP or less, 5 wt-% DAP and/or MAP or less, 1 wt-% DAP and/or MAP or less, or 0.1 wt-% DAP and/or MAP or less.

In one or more embodiments, the outermost layer can include a polycation polymer. In one or more embodiments, the polycation polymer is or includes a polysaccharide. Examples of polysaccharides include D-glucosamine, chitosan, chitin or any combination thereof. In one or more embodiments, the outermost layer includes chitosan (Chemical Abstract Services Number: 0912-76-4). In one or more embodiments, the outermost layer includes chitin (Chemical Abstract Services Number: 1398-61-4). In one or more embodiments, the outermost layer includes D-glucosamine. In one or more embodiments, the polycation polymer can include D-glucosamine. In one or more embodiments, the polycation polymer can include chitosan. In one or more embodiments, the polycation polymer can include chitin. A chitosan layer may be able to withstand surface erosion if the outermost layer of the particle includes nanoS and/or nanoBC while also permeating phosphorous in a sustained manner.

In one or more embodiments, the outermost layer includes 0.01 wt-% polycation polymer or greater, 0.1 wt-% polycation polymer or greater, 1 wt-% polycation polymer or greater, 5 wt-% polycation polymer or greater, 10 wt-% polycation polymer or greater, 20 wt-% polycation polymer or greater, 30 wt-% polycation polymer or greater, 40 wt-% polycation polymer or greater, 50 wt-% polycation polymer or greater, 60 wt-% polycation polymer or greater, 70 wt-% polycation polymer or greater, 80 wt-% polycation polymer or greater, or 90 wt-% polycation polymer or greater. In one or more embodiments, the outermost layer includes 99 wt-% polycation polymer or less, 90 wt-% polycation polymer or less, 80 wt-% polycation polymer or less, 70 wt-% polycation polymer or less, 60 wt-% polycation polymer or less, 50 wt-% polycation polymer or less, 40 wt-% polycation polymer or less, 30 wt-% polycation or less, 20 wt-% polycation polymer or less, 10 wt-% polycation polymer or less, 5 wt-% polycation polymer or less, 1 wt-% polycation polymer or less, or 0.1 wt-% polycation polymer or less. In one or more embodiments, the outermost layer includes 1 wt-% to 10 wt-% such as 1 wt-% to 5 wt-% polycation polymer.

In one or more embodiments where the outermost layer includes biochar, DAP and/or MAP, and sulfur (e.g., nanoS) the layer may serve at least three purposes. The permeation of phosphorus from the polymer coated/layered core is expected to be slow to meet plant phosphorus demand during the later growth stage. Biochar impregnated with DAP and/or MAP may allow the particle to supply phosphorous to plants during early growth stage. The outermost layer may impart abrasion resistance and/or mechanical stability to the particle. The outermost sulfur (e.g., nanoS) in the outermost layer can contribute towards maintaining an appropriate hydrophilic (with other layers such as chitosan layers and polyanion polymer layers) and hydrophobic (with nanoS) balance required to stabilize the layers on the core, while also improving the outcome of nutrient-nutrient interaction with phosphorus.

In one or more embodiments, the ratio of elemental sulfur (e.g., nanoS) to biochar (e.g., nanobiochar) is 1 to 1. In one or more embodiments, the ratio of elemental sulfur (e.g., nanoS) to biochar (e.g., nanobiochar) in the outermost layer is 1 to 1.

In one or more embodiments, the outmost layer includes a polyanion polymer. The polyanion polymer may be polymerized from an organic acid, such as, for example, citric acid, oxalic acid, gluconic acid, formic acid, acetic acid, or the like. The polyanion polymer can be polymerized from two monomers. The polyanion polymer can be polymerized from a first multifunctional monomer and a second multifunctional monomer. For example, the polyanion polymer can be polymerized from citric acid and glycerol. The release of phosphorus from a core such as rock phosphate or hydroxyapatite is slow. The inclusion of a polymer polymerized from at least an organic acid may allow for a more rapid release of phosphorous from the core. In one or more embodiments, the polyanion polymer is polymerized from at least citric acid. In one or more embodiments, the polyanion polymer is polymerized from citric acid and glycerol. In one or more embodiments, the polyanion polymer is a branched polymer. In one or more embodiments, the polyanion polymer is a branched polymer polymerized from at least citric acid. In one or more embodiments, the polyanion polymer is a branched polymer polymerized from at least citric acid and glycerol.

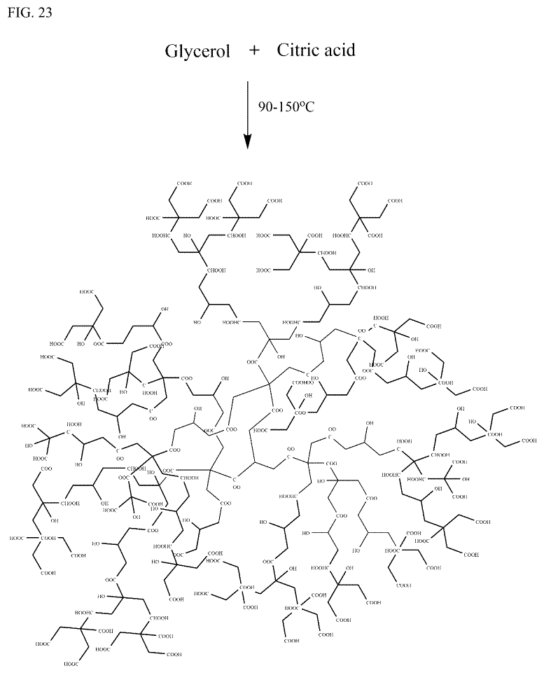

In one or more embodiments, the outermost layer includes citric acid. In one or more embodiments, the outermost layer includes glycerol. In one or more embodiments, the outermost layer includes a polymer polymerized from citric acid (or citrate) and glycerol, also called a poly(citric acid-co-glycerol) In one or more embodiments the poly(citric acid-co-glycerol) is a branched polymer. In one or more embodiments, poly(citric acid-co-glycerol), the polymer is a hyperbranched polymer (FIG. 23). Hyperbranched polymers are characterized by highly branched structures and large numbers of end functional groups as seen in FIG. 23. Hyperbranched polymers may also have low intrinsic viscosities, very high solubility, or both. To synthesize a branched or highly branched poly(citric acid-co-glycerol) citric acid (CA) monohydrate may be used as an AB3 monomer and glycerol (G) used as an A3 monomer.

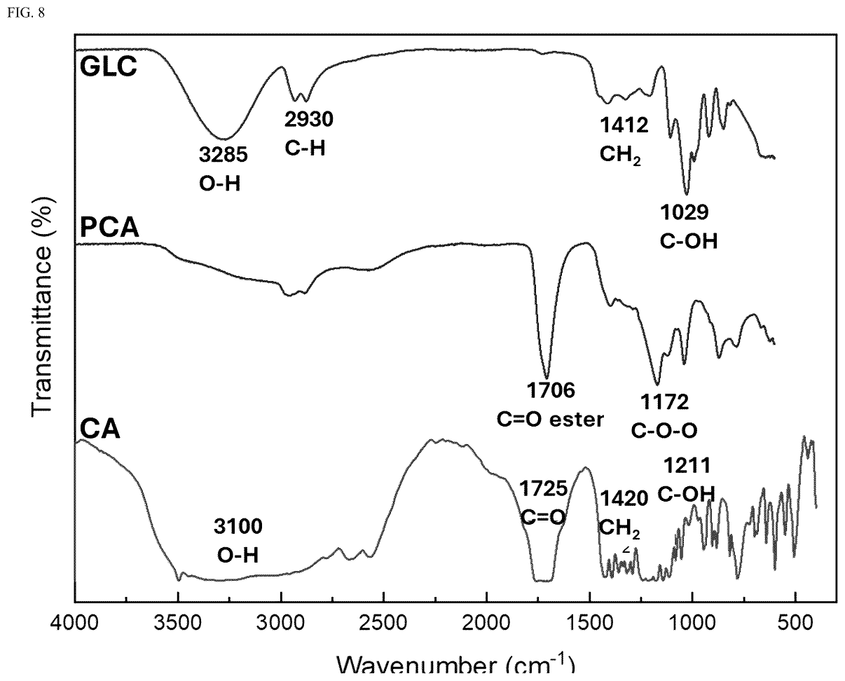

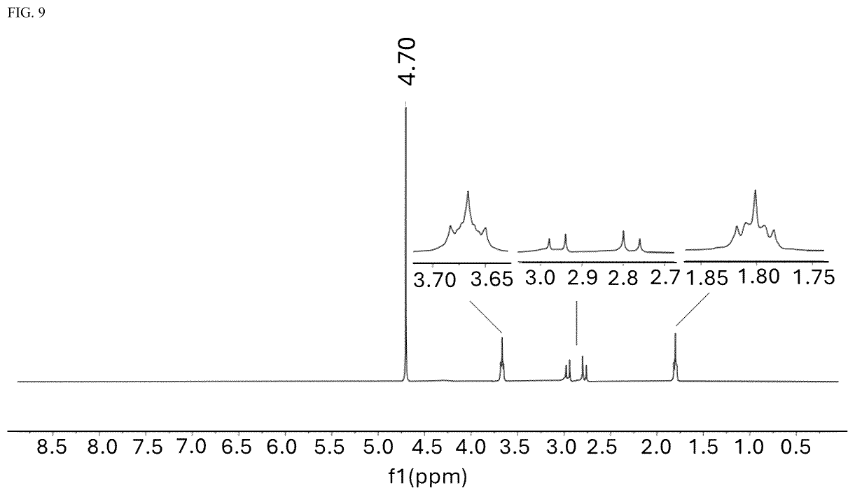

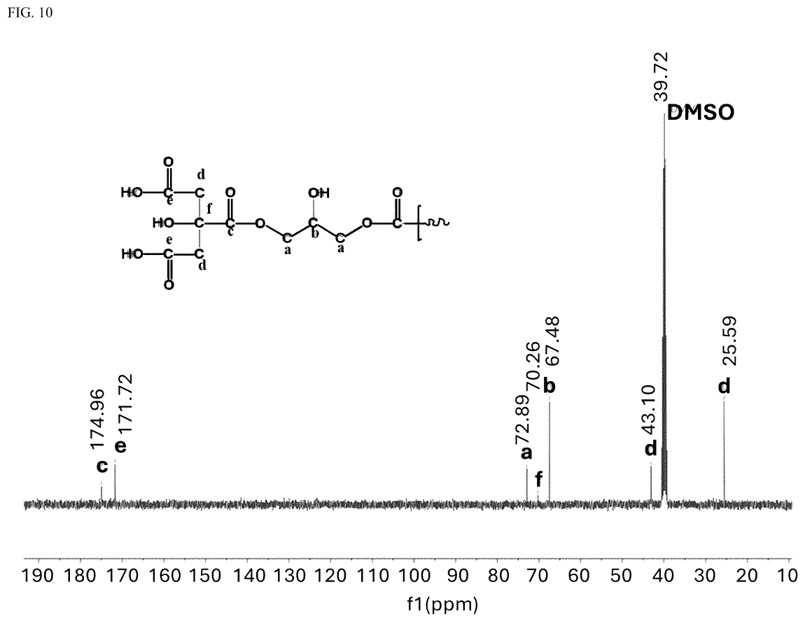

FIG. 8, FIG. 9, and FIG. 10 show FTIR, Hydrogen Nuclear Magnetic Resonance (¹H NMR), and Carbon Nuclear Magnetic Resonance (¹³C NMR) characterization data respectively, supporting the successful synthesis of hyperbranched polymer made from polymerizing glycerol and citric acid (termed PCA in the figures) using step-by-step thermal polycondensation. FIG. 9 shows peaks at 2.7-3 ppm assigned to the AB system of methylene protons of citric acid building blocks. The glycerol building blocks exhibited signals at about 1.8 ppm and 3.6 ppm, corresponding to the methine (—CH—) and methylene (—CH₂—) groups, respectively. The signal around 4.70 ppm corresponds to the hydroxyl groups (water molecules) present in the polymer matrix. In FIG. 10, the signals (d) and (f) observed at around 43.0 ppm and 70 ppm were assigned to the citric acid monomer units, while the carbon signals (b) and (a) at about 68.0 ppm and 73 ppm were attributed to the glycerol monomer units. The signal observed at approximately 172 ppm was assigned to the two carbon atoms (e) of the acidic carbonyl groups in the citric acid comonomer unit, while the signal at roughly 26.0 ppm was attributed to the carbon (d) bonded to the carboxyl groups in the same unit. The peak at 175 ppm was assigned to the esteric carbonyl groups (c).

In one or more embodiments, a poly(citric acid-co-glycerol) polymer in the outermost layer has a molar ratio of glycerol to citric acid of 1 mole or greater glycerol for every 1 mole of citric acid, 5 moles or greater of glycerol or greater for every one 1 of citric acid, 8 moles or greater of glycerol for every 1 mole of citric acid, or 12 moles or greater of glycerol for every 1 mole of citric acid. In one or more embodiments, a poly(citric acid-co-glycerol) polymer in the outermost layer has a molar ratio of glycerol to citric acid of 15 moles of less glycerol for every 1 mole of citric acid, 12 moles or less of glycerol for every 1 mole of citric acid, 8 moles or less glycerol for every 1 mole citric acid, 5 moles or less glycerol for every 1 mole citric acid, or 5 moles of less glycerol for every 1 mole of citric acid.

In one or more embodiments, a poly(citric acid-co-glycerol) polymer in the outermost layer includes 0.01 mol-% glycerol or greater, 0.1 mol-% glycerol or greater, 1 mol-% glycerol or greater, 5 mol-% glycerol or greater, 10 mol-% glycerol or greater, 20 mol-% glycerol or greater, 30 mol-% glycerol or greater, 40 mol-% glycerol or greater, 50 mol-% glycerol or greater, 60 mol-% glycerol or greater, 70 mol-% glycerol or greater, 80 mol-% glycerol or greater, or 90 mol-% glycerol or greater. In one or more embodiments, a poly(citric acid-co-glycerol) polymer in the outermost layer includes 99 mol-% glycerol or less, 90 mol-% glycerol or less, 80 mol-% glycerol or less, 70 mol-% glycerol or less, 60 mol-% glycerol or less, 50 mol-% glycerol or less, 40 mol-% glycerol or less, 30 mol-% glycerol or less, 20 mol-% glycerol or less, 10 mol-% glycerol or less, 5 mol-% glycerol or less, 1 mol-% glycerol or less, or 0.1 mol-% glycerol or less.

In one or more embodiments, the poly(citric acid-co-glycerol) in the outermost layer includes 0.01 mol-% citric acid or greater, 0.1 mol-% citric acid or greater, 1 mol-% citric acid or greater, 5 mol-% citric acid or greater, 10 mol-% citric acid or greater, 20 mol-% citric acid or greater, 30 mol-% citric acid or greater, 40 mol-% citric acid or greater, 50 mol-% citric acid or greater, 60 mol-% citric acid or greater, 70 mol-% citric acid or greater, 80 mol-% citric acid or greater, or 90 mol-% citric acid or greater. In one or more embodiments, the poly(citric acid-co-glycerol) in the outermost layer includes 99 mol-% citric acid or less, 90 mol-% citric acid or less, 80 mol-% citric acid or less, 70 mol-% citric acid or less, 60 mol-% citric acid or less, 50 mol-% citric acid or less, 40 mol-% citric acid or less, 30 mol-% citric acid or less, 20 mol-% citric acid or less, 10 mol-% citric acid or less, 5 mol-% citric acid or less, 1 mol-% citric acid or less, or 0.1 mol-% citric acid or less.

In one or more embodiments, the particle 1 includes one or more layers in addition to the outermost layer (e.g., layer 20 and layer 30 in FIG. 1). Each layer may include a different material. The layers may be in an order relative to the core. For example, the first layer can be disposed on at least a portion of the core. A second layer can be disposed on at least a portion of the first layer. A third layer can be disposed on at least a portion of the second layer. A fourth layer can be disposed on at least a portion of the third layer. An outermost layer can be disposed on at least apportion of a first layer, a second layer, a third layer, a fourth layer, and so on. In embodiments, where the particle 1 includes only 1 layer, the first layer is the outermost layer.

In one or more embodiments, one or more layers includes a polyanion polymer. In one or more embodiments, a layer other than, or in addition to, the outermost layer includes a polyanion polymer. The polyanion polymer may be polymerized from an organic acid, such as, for example, citric acid, oxalic acid, gluconic acid, formic acid, acetic acid, or the like. The polyanion polymer can be polymerized from two monomers. The polyanion polymer can be polymerized from a first multifunctional monomer and a second multifunctional monomer. For example, the polyanion polymer can be polymerized from citric acid and glycerol. The release of phosphorus from a core such as rock phosphate or hydroxyapatite is slow. The inclusion of a polymer polymerized from at least an organic acid may allow for a more rapid release of phosphorous from the core. In one or more embodiments, the polyanion polymer is polymerized from at least citric acid. In one or more embodiments, the polyanion polymer is polymerized from citric acid and glycerol. In one or more embodiments, the polyanion polymer is a branched polymer. In one or more embodiments, the polyanion polymer is a branched polymer polymerized from at least citric acid. In one or more embodiments, the polyanion polymer is a branched polymer polymerized from at least citric acid and glycerol.

In one or more embodiments, one or more layers other than, or in addition to, the outer most layer includes citric acid. In one or more embodiments, one or more layers other than, or in addition to, the outermost layer includes glycerol. In one or more embodiments, one or more layers other than, or in addition to the outermost layer includes a polymer polymerized from citric acid (or citrate) and glycerol, also called a poly(citric acid-co-glycerol) In one or more embodiments the poly(citric acid-co-glycerol) is a branched polymer. In one or more embodiments, the poly(citric acid-co-glycerol) is a hyperbranched polymer (FIG. 23). For example, citric acid (CA) monohydrate may be used as an AB3 monomer and glycerol (G) used as an A3 monomer to create a branched or hyperbranched polymer formed from citric acid and glycerol monomers.

In one or more embodiments, the citric acid-glycerol polymer poly(citric acid-co-glycerol) polymer has a molar ratio of glycerol to citric acid of 1 mole or greater glycerol for every 1 mole of citric acid, 5 moles or greater of glycerol or greater for every one 1 of citric acid, 8 moles or greater of glycerol for every 1 mole of citric acid, or 12 moles or greater of glycerol for every 1 mole of citric acid. In one or more embodiments, the poly(citric acid-co-glycerol) polymer has a molar ratio of glycerol to citric acid of 15 moles of less glycerol for every 1 mole of citric acid, 12 moles or less of glycerol for every 1 mole of citric acid, 8 moles or less glycerol for every 1 mole citric acid, 5 moles or less glycerol for every 1 mole citric acid, or 5 moles of less glycerol for every 1 mole of citric acid.

In one or more embodiments, the citric acid-glycerol polymer poly(citric acid-glycerol) polymer includes 0.01 mol-% glycerol or greater, 0.1 mol-% glycerol or greater, 1 mol-% glycerol or greater, 5 mol-% glycerol or greater, 10 mol-% glycerol or greater, 20 mol-% glycerol or greater, 30 mol-% glycerol or greater, 40 mol-% glycerol or greater, 50 mol-% glycerol or greater, 60 mol-% glycerol or greater, 70 mol-% glycerol or greater, 80 mol-% glycerol or greater, or 90 mol-% glycerol or greater. In one or more embodiments, poly(citric acid-glycerol) polymer includes 99 mol-% glycerol or less, 90 mol-% glycerol or less, 80 mol-% glycerol or less, 70 mol-% glycerol or less, 60 mol-% glycerol or less, 50 mol-% glycerol or less, 40 mol-% glycerol or less, 30 mol-% glycerol or less, 20 mol-% glycerol or less, 10 mol-% glycerol or less, 5 mol-% glycerol or less, 1 mol-% glycerol or less, or 0.1 mol-% glycerol or less.

In one or more embodiments, the poly(citric acid-glycerol) polymer includes 0.01 mol-% citric acid or greater, 0.1 mol-% citric acid or greater, 1 mol-% citric acid or greater, 5 mol-% citric acid or greater, 10 mol-% citric acid or greater, 20 mol-% citric acid or greater, 30 mol-% citric acid or greater, 40 mol-% citric acid or greater, 50 mol-% citric acid or greater, 60 mol-% citric acid or greater, 70 mol-% citric acid or greater, 80 mol-% citric acid or greater, or 90 mol-% citric acid or greater. In one or more embodiments, the poly(citric acid-glycerol) polymer includes 99 mol-% citric acid or less, 90 mol-% citric acid or less, 80 mol-% citric acid or less, 70 mol-% citric acid or less, 60 mol-% citric acid or less, 50 mol-% citric acid or less, 40 mol-% citric acid or less, 30 mol-% citric acid or less, 20 mol-% citric acid or less, 10 mol-% citric acid or less, 5 mol-% citric acid or less, 1 mol-% citric acid or less, or 0.1 mol-% citric acid or less.

Experiments suggest that a citric acid only coating on rock phosphate may not be very stable. Polymeric coatings bearing multiple electrostatic charges can increase molecular adhesion with polyelectrolyte-coated surface (e.g., a chitosan coated surface) bearing complementary electrostatic charge. As such, it is thought that multivalent polymers polymerized from citric acid and/or glycerol may increase adhesion of the multivalent positively charged functional groups of chitosan to form stable layers and/or particles.

In one or more embodiments, one or more layers other than, or in addition to, the outermost layer may include a polycation polymer. Examples of polysaccharides include D-glucosamine, chitosan, or any combination thereof. In one or more embodiments, one or more layers other than, or in addition to, the outermost layer includes chitosan (Chemical Abstract Services Number: 0912-76-4). In one or more embodiments, one or more layers other than, or in addition to, the outermost layer includes chitin (Chemical Abstract Services Number: 1398-61-4). In one or more embodiments, one or more layers other than, or in addition to, the outermost includes D-glucosamine. In one or more embodiments, the polycation polymer can include D-glucosamine. In one or more embodiments, the polycation polymer can include chitosan. In one or more embodiments, the polycation polymer can include chitin. In one or more embodiments, the first layer disposed on at least a portion of the core includes chitin. A chitosan layer may be able to withstand surface erosion if the outermost layer of the particle includes nanoS and/or nanoBC while also permeating phosphorous in a sustained manner.

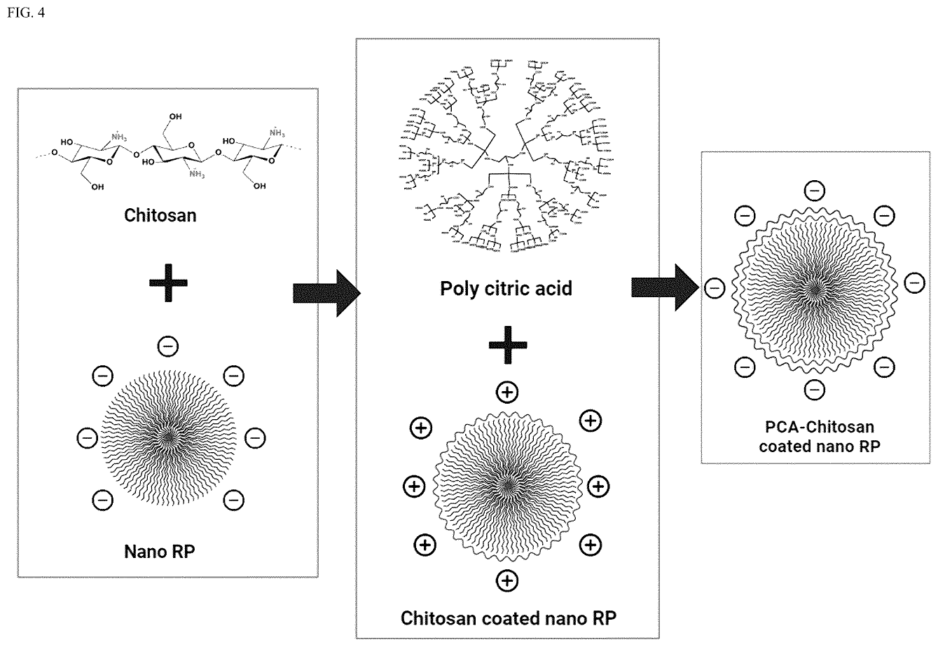

The layers of the particle may be adhered to each other through a variety of mechanisms and/or forces including, for example, electrostatic forces, adsorption, absorption, hydrophilic interactions, hydrophobic interactions, and the like. For example, a layer having one or more positive charges can electrostatically interact with an adjacent layer having one or more negative charges. A layer that includes a polycation polymer and a layer that includes a polyanion polymer can electrostatically interact. For example, a layer that includes chitosan and a layer that includes a polymer formed from citric acid and/or glycerol can electrostatically interact due to the polycation nature of chitosan and the polyanion nature of citric acid (see, for example, FIG. 4).

In one or more embodiments, the particle includes alternating layers of a polycation polymer containing layer (e.g., a chitosan containing layer) and a layer containing a polyanion polymer (e.g., a polymer formed from citric acid and/or glycerol). For example, a particle may include 1, 2, 3, 4, 5, 6, 7, 8, or 9 polycation polymer containing layers and 1, 2, 3, 4, 5, 6, 7, 8, or 9 polyanion polymer containing layers where the polycation containing layers and the polyanion polymer containing layers are alternated. For example, a particle may include a first layer that includes a polycation polymer, a second layer that includes a polyanion polymer, a third layer that includes a polycation polymer, a fourth layer that includes a polyanion polymer and so on. The composition of each polycation polymer containing layer in a particle that includes alternating polycation polymer and polyanion polymer containing layers may be the same or different. The composition of each polyanion polymer containing layer in a particle that includes alternating polycation polymer and polyanion polymer containing layers may be the same or different.

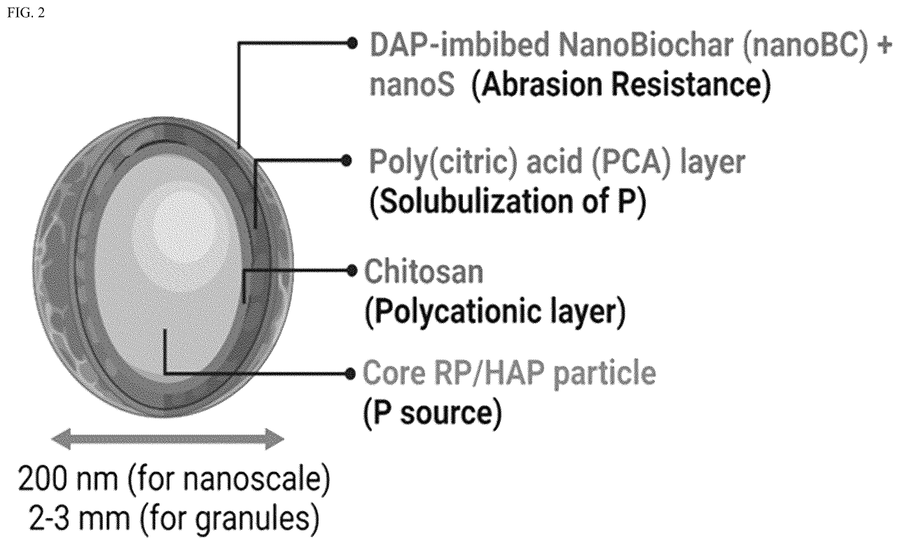

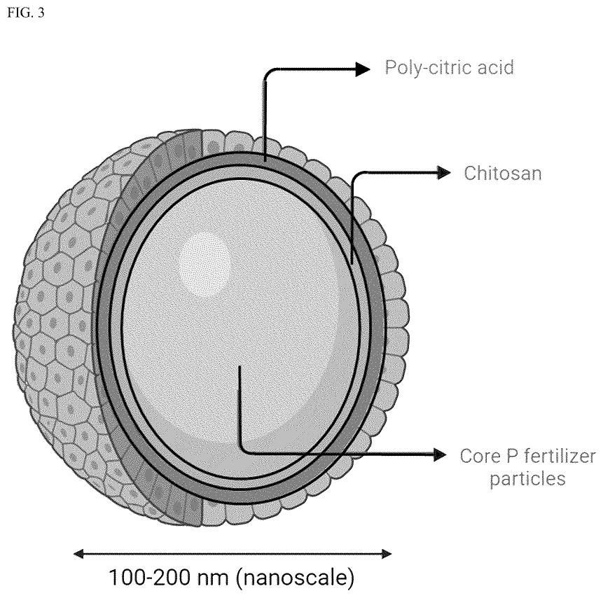

Returning to FIG. 1, in one or more embodiments, the particle 1 includes a first layer 20 disposed on the core 10, a second layer 30 disposed on the first layer 20, and a third layer 40 disposed on the third layer 40. In one or more embodiments, the first layer 20 includes a polycation polymer. In one or more embodiments, the first layer 20 includes a chitin. In one or more embodiments, the second layer 30 includes a polyanion polymer. In one or more embodiments, the second layer 30 includes poly(citric acid-co-glycerol) In one or more embodiments the first layer 20 includes a polycation polymer and the second layer 30 includes a polyanion polymer. In one or more embodiments the first 20 layer includes a chitosan and the second layer 30 includes poly(citric acid-co-glycerol) In one or more embodiments, the third layer 40 is the outermost layer and includes biochar (e.g., nano-biochar). In one or more embodiments, the third layer 40 is the outermost layer and includes sulfur (e.g., elemental sulfur and/or nano-sulfur). In one or more embodiments, the third layer 40 is the outermost layer and includes DAP. In one or more embodiments, the third layer 40 is the outermost layer and includes MAP. In one or more embodiments, the third layer 40 is the outermost layer and includes biochar (e.g., nano-biochar), sulfur (e.g., elemental sulfur and/or nano-sulfur), DAP, MAP, or any combination thereof. FIG. 2 and FIG. 3 also show configurations and materials of particle layers.

A particle can include 1 or more bilayers, each bilayer including a polycation polymer containing layer and a polyanion polymer containing layer. In one or more embodiments, a particle includes 1, 2, 3, 4, 5, 6, 7, 8, 9, or 10 bilayers.

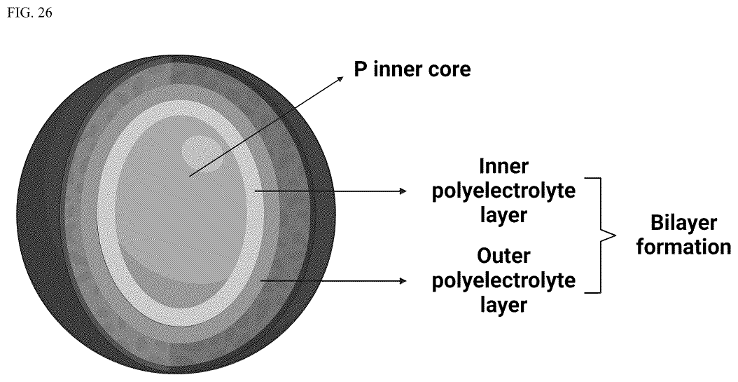

FIG. 26 shows another configuration of a particle. The particle includes a rock phosphate or nano-rock phosphate core, and a bilayer. The bilayer includes an inner polyelectrolyte layer and an outer polyelectrolyte layer. The inner polyelectrolyte layer is disposed on at least a portion of the core. The outer polyelectrolyte layer is disposed on at least a portion of the inner polyelectrolyte layer. The inner polyelectrolyte layer can include a polycation polymer. In one or more embodiments, the inner polyelectrolyte layer includes chitosan. The outer polyelectrolyte layer can include a polyanion polymer. In one or more embodiments, the outer polyelectrolyte layer includes poly(citric acid-glycerol). The first polyelectrolyte layer (inner polyelectrolyte layer). The particle can include an outermost layer disposed on at least a portion of the outer polyelectrolyte later.

The thickness of each layer may vary. The thickness of each layer can be independent of the thickness of every other layer and the core. In or more embodiments, a layer has a thickness of 1 nm or greater, 2 nm or greater, 5 nm or greater, 10 nm or greater, 15 nm or greater, 20 nm or greater, 25 nm or greater, 50 nm or greater, 100 nm or greater, 200 nm or greater, 300 nm or greater, 400 nm or greater, 500 nm or greater, 600 nm or greater, 700 nm or greater, 800 nm or greater, 900 nm or greater, 1000 nm or greater, 1200 nm or greater, 1400 nm or greater, 1600 nm or greater, 1800 nm or greater, 2000 nm or greater, 2200 nm or greater, 2400 nm or greater, 2600 nm or greater, 2800 nm or greater, 3000 nm or greater, 3200 nm or greater, 3400 nm or greater, 3600 nm or greater, 3800 nm or greater, 4000 nm or greater, or 4500 nm or greater. In one or more embodiments, a layer has a thickness of 5000 nm or less, 4500 nm or less, 4000 nm or less, 3800 nm or less, 3600 nm or less, 3400 nm or less, 3200 nm or less, 3000 nm or less, 2800 nm or less, 2600 nm or less, 2400 nm or less, 2200 nm or less, 2000 nm or less, 1800 nm or less, 1600 nm or less, 1400 nm or less, 1200 nm or less, 1000 nm or less, 800 nm or less, 600 nm or less, 400 nm or less, 200 nm or less, 100 nm or less, 50 nm or less, 25 nm or less, 5 nm or less, 2 nm or less.

In one or more embodiments, a layer has a thickness of 1 nm to 100 nm, such as 1 nm to 50 nm, 1 nm to 25 nm, or 1 nm to 10 nm. In one or more embodiments, a layer has a thickness of 200 nm to 5000 nm, such as 200 nm to 500 nm, or 200 nm to 400 nm.

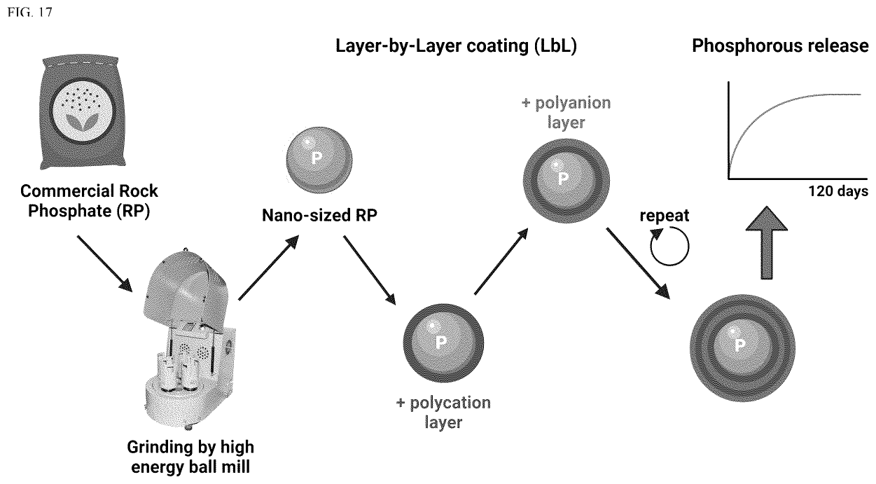

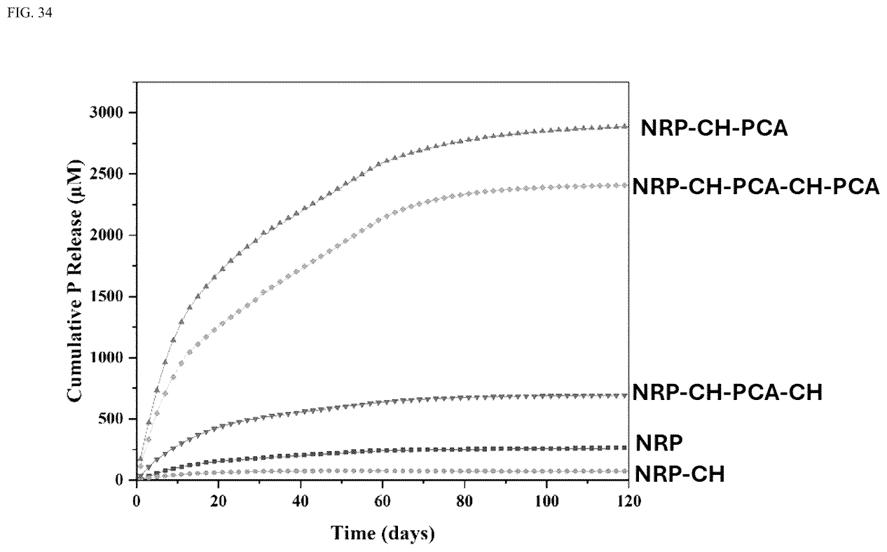

FIG. 17 is a schematic representation of the preparation and coating process of nano-rock phosphate for controlled phosphorus release. Commercial rock phosphate is initially ground using a high-energy ball mill to achieve nano-sized particles. These particles undergo a layer-by-layer (LbL) coating process, where alternating layers of polycation polymer and polyanion polymers are applied. The layering cycle can be repeated to build multiple layers around the nano-sized rock phosphate core. The final coated nano-rock phosphate structure can allow for the controlled release of phosphorus over an extended period, as depicted by the release profile over 120 days as seen in FIG. 34. This process enhances the efficiency and sustainability of phosphorus use in agricultural applications.

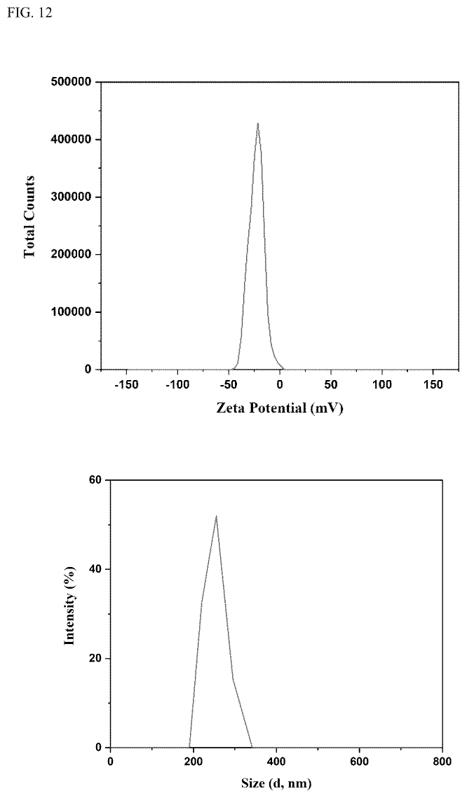

FIG. 12 shows the characterization of nano-rock phosphate particles using zeta potential (top) and particle size distribution analysis (bottom). The top graph shows the zeta potential of nano rock phosphate, with a peak centered around −20 mV, indicating a moderately stable colloidal suspension due to electrostatic repulsion between particles. This negative zeta potential suggests the surface charge of the particles is sufficiently strong to prevent aggregation, contributing to stability in aqueous suspensions. The bottom graph displays the particle size distribution, with the majority of particles exhibiting a size around 250 nm, as shown by the peak intensity near this diameter. This narrow distribution indicates a uniform particle size. A uniform particle size can allow for consistent reactivity and controlled release in applications involving nano-rock phosphate.

The particles can be made using a layer-by-layer technique. The layer-by-layer technique may be centrifugation based and/or a fluidized bed process. To produce particles (granules) starting from cores on the millimeter scale, the fluidized bed process may be advantageous. To produce nano-sized particles starting from nano-sized cores, the centrifugation process may be advantageous. The layer-by-layer (LbL) technique can be used to make particles by sequentially depositing oppositely charged polymers to build a highly stable film with polyanion polymers (e.g., poly(citric acid-co-glycerol)) and a polycation polymer (e.g., chitosan) atop a nanosized core. It is thought that this technique can produce particles that allow for precise control and more efficient delivery kinetics of phosphorus at nanometer scale level and overall diffusion of nanoscale fertilizers into soil.

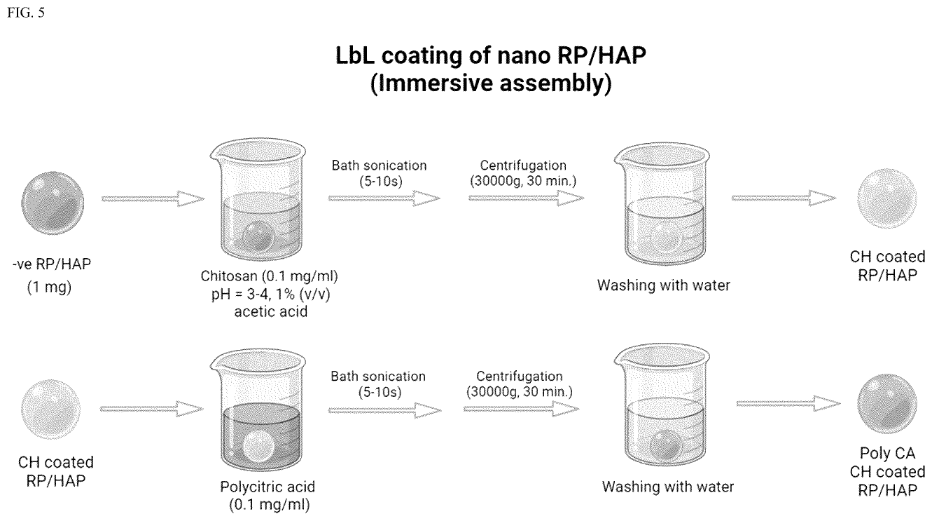

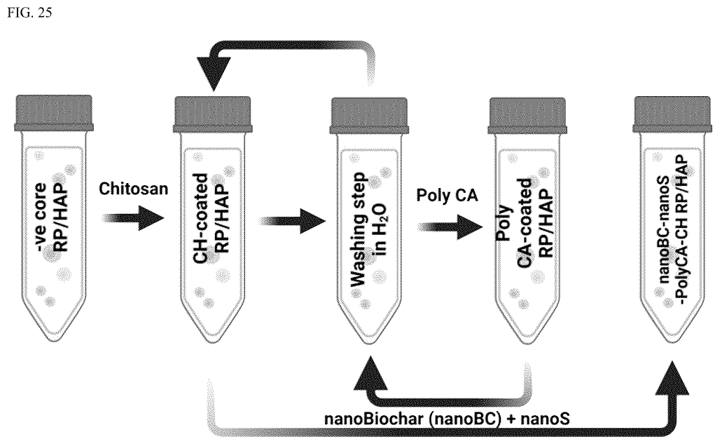

A centrifugation based LbL process may include coating the negatively charged cores (e.g., rock phosphate or hydroxyapatite having for example, a 120 nm in hydrodynamic size; −200 mV) with a polycation polymer (e.g., chitosan; e.g., 50 μg/mL polycation polymer for each 1 mg/mL of core suspension). The mixing may be facilitated by a brief period of bath sonication (e.g., 3 to 5 seconds), followed by a washing step through centrifugation (e.g., 30000 g, 30 min) (see, for example, FIG. 5). To next incorporate a polyanion polymer (e.g., a polymer polymerized from citric acid and glycerol) the particles having the chitosan coating may be mixed with an aqueous polyanion polymer solution (e.g., 10 micromolar polyanion polymer), followed by further purification. These two coating steps may be repeated to achieve many bilayers (each bilayer includes 1 layer containing a polycation polymer and 1 layer containing a polyanion polymer). An additional layer that includes a polycation polymer can be added as well as a final outermost layer that includes, for example, biochar and/or elemental sulfur. For disposing a polycation polymer (e.g., chitosan) containing layer, acidic water (e.g., pH controlled to 3.0-4.0) may be used as a carrier. For the layering process to dispose a polyanion polymer, distilled water may be used as a carrier. This overall process of LbL functionalization is shown in FIG. 5 and FIG. 25.

A fluidized bed based LbL process may include a Wurster fluidized bed process. The Wurster fluidized bed is designed so that the particles are forced to follow a circular flow trajectory. Generally, the Wurster bed is divided into two zones, each zone exhibiting a different gas velocity. In the high velocity zone, a jet of gas is used to propel or pneumatically convey the particles upwardly. When the particles reach a certain height, they “spout” violently and fall into the low velocity or “subsidence” zone due to gravity. The spray nozzle through which the coating material is sprayed onto the granules' surface is placed at the bottom of the high velocity zone. This cyclic movement of particles is repeated several times until an adequate coating has been grown around the particles as a function of initial particle size distribution. Supplying different coating solutions (e.g., containing a polycation polymer such as chitosan or containing a polyanion polymer such as a polymer polymerized from citric acid and glycerol) can be used to create alternating layers on the core. The process may include passing core particles through a sieve (e.g., 3.36 mm, #6) to be retained on second sieve (e.g., 2.00 mm sieve, #10) to obtain uniform sized core particles (e.g., ˜2 to 3 mm). The layer-forming material can be aqueous solutions of a polyanion polymer (e.g., a poly(citric acid-co-glycerol)) polymer at a concentration=1 to 10 mM, pH 7.4) and polycation polymer (e.g., chitosan at a concentration of 1 to 10 mM, pH 4.0 in an acetate buffer). As a plasticizer, glycerol can be used (e.g., at 1% concentration of the coating dispersion) in the coating solutions. An aqueous dispersion of DAP and/or MAP impregnated biochar (e.g., nanobiochar) and elemental sulfur (e.g., nanoS; mixed at 1:1 ratio, the total concentration of the mixture may be 1% w/w of the coating dispersion), stabilized by sodium dodecyl sulfate (SDS) may be used to from the outermost layer or the particle. The final product can attain the general architecture as shown in FIG. 2. For coating solutions, the following parameters may be beneficial: dry solids content=55.12%; density=1.282 kg/dm³; interfacial tension=30 to 40 dynes/cm; dynamic viscosity at 20° C.=14 cP; and a minimum film-forming temperature=15 to 25° C. The surface characteristics of the resultant particles can be examined with the aid of a scanning electron microscope. Kinetic-release experiments can be carried out in distilled water in order to determine the release characteristics of phosphorus from the particles. The combined polycation polymer/polyanion polymer bilayer thickness can be ≤500 micrometers, and can be evaluated using optical microscopy.

The surface morphology and cross-section of final particles and particles in the process of being prepared may be examined using, for example, transmission electron microscopy, scanning electron microscopy, dynamic light scattering, and/or laser doppler electrophoresis (for zeta-potential). The water contact angle may be measured using a Kruss-type Contact Angle meter, pH-adjusted PBS buffer, on APTES-modified Si wafers. Quartz crystal microbalance with dissipation monitoring (QCM-D) measurements may be done using an amine-modified gold surface measurement substrate, prepared by incubating a gold-coated sensor crystals in 1 mM 11-amino-1-undecanethiol hydrochloride. For QCM-D experiments, 10 mM tris buffer with 150 mM NaCl (pH 7.5) can be first injected in order to obtain a stable baseline, followed by addition of polyelectrolyte solutions (100 microliter/min) for 70 min and then static incubation for 20 min. Finally, a buffer wash can be performed in the same pH condition and the final change in resonance frequency (delta f) recorded. Kinetic-release experiments can be carried out in distilled water in order to determine the release characteristics of phosphorus from the particles.

Layer deposition can be identified and characterized using, for example, transmission electron microscopy (TEM), scanning electron microscopy (SEM), infrared spectroscopy, energy dispersive X-ray spectroscopy (EDS), and X-ray photoelectron spectroscopy. Computerized tomography (micro-CT) can also be evaluated to understand the porosity and microstructures of the coatings on top of the core.

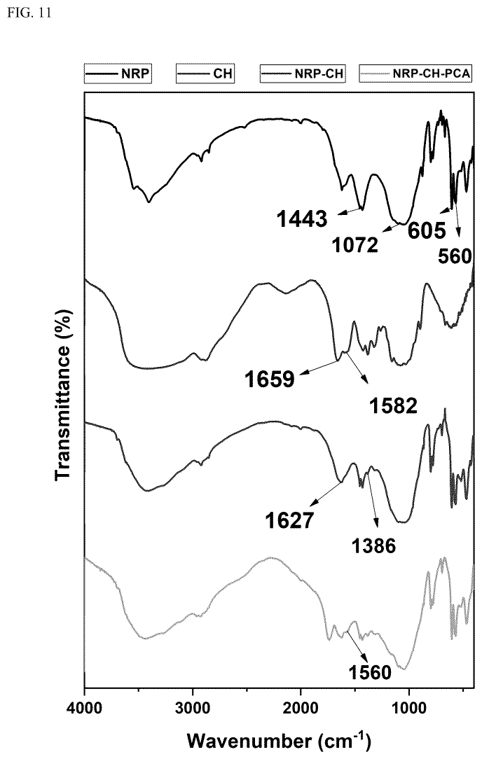

FIG. 11 shows Fourier-transform infrared spectroscopy (FTIR) characterization data of nano-rock phosphate (NRP); chitosan (CH); a particle having a NRP core and a first layer of CH disposed on the core (RP-CH); and a particle having NRP core, a CH containing first layer disposed on the core, and a poly(citric acid-co-glycerol) containing second layer disposed on the first layer (RP-CH-PCA). The differences and similarities between the traces indicate successful synthesis of an CH and PCA coated NRP particle. NRP showed a cluster of bands characteristic of phosphate (PO₄³⁻) at 560, 605, and 1072 cm⁻¹⁶¹. Two conjoint weak bands of CO₃²⁻ appeared at 1443 cm⁻¹. The FT-IR spectra of CH were in line with previous studies. The characteristic peaks that appeared at 1659 cm⁻¹ and 1582 cm⁻¹ are attributed to the amide-I and amide-II vibration bands, respectively. Chitosan's hydroxyl (—OH) and amine (—NH₂) groups likely cause a broader peak in the region (3200-3600 cm⁻¹) in the NRP-CH spectrum due to hydrogen bonding with the phosphate groups in NRP. In NRP-CH, the protonation of CH amine functionalities was suggested by the presence of the band, attributed to NH³⁺ groups, namely the bending vibration at 1386 cm⁻¹. This was conditioned by the formation of electrostatic bonds with NRP. Moreover, a low-frequency shift of the amide was observed by a band at 1659 cm⁻¹ of CH to 1627 cm⁻¹, which indicates the participation of the carbonyl groups of the CH amide groups in hydrogen bonding with hydroxyl groups of NRP. The appearance of an additional peak in the region (1600-1750 cm⁻¹) for NRP-CH-PCA is due to the introduction of PCA, which contains multiple carboxyl groups. CH's latter peak of 1582 cm⁻¹ moved to a low-frequency region (1560 cm⁻¹) for NRP-CH-PCA. This result indicates the —NH₂ in NRP-CH-PCA has been protonated to —NH₃⁺ and the sample is essentially in the acetate form. Consequently, it is confirmed that ionic interactions exist in NRP-CH-PCA.

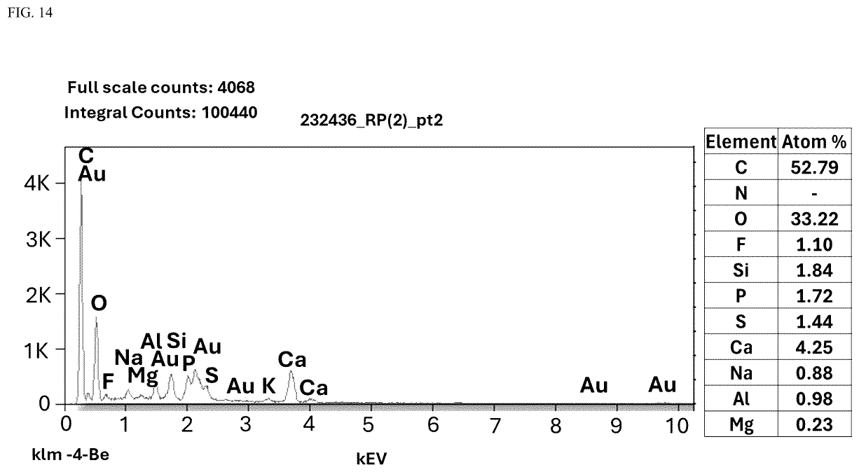

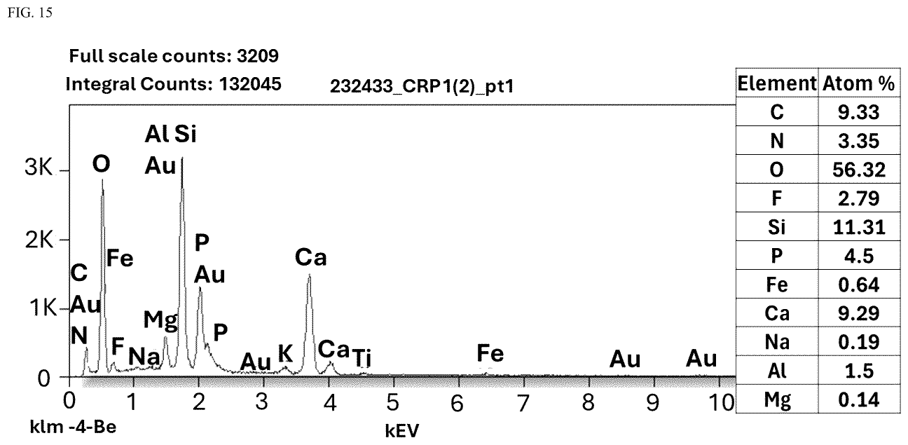

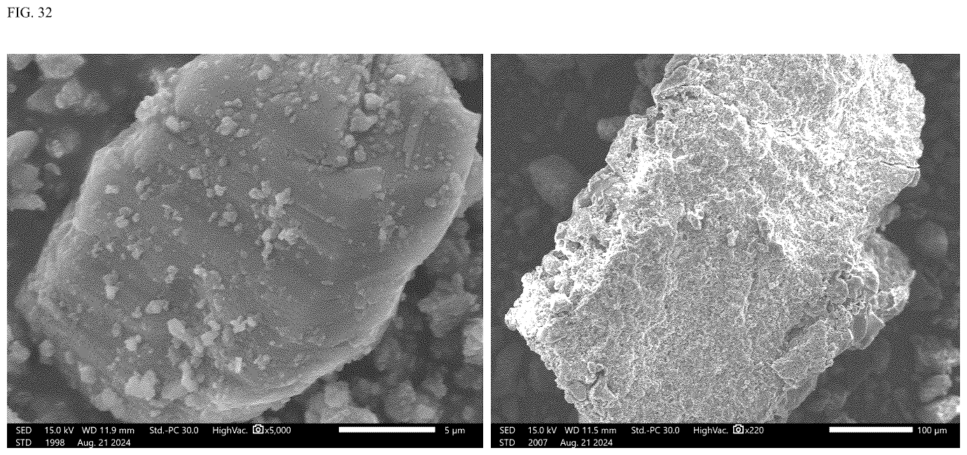

FIG. 32 show scanning electron microscopy (SEM) images of NRP before coating (FIG. 32 left) and after coating with the polycation polymer (chitosan) and polyanion polymer layers (poly(citric acid-glycerol) FIG. 32 right). The coatings form a relatively uniform and continuous layer around the NRP particles, demonstrating strong adherence and effective surface coverage. FIG. 14 and FIG. 15 show the elemental analysis of NRP (FIG. 14) and a particle having a NRP core and a first layer containing chitosan (FIG. 15). The observed increase in size from the NRP to the chitosan-coated NRP, surface roughness as well as the difference in elemental analysis indicate successful deposition of chitosan on the NRP.

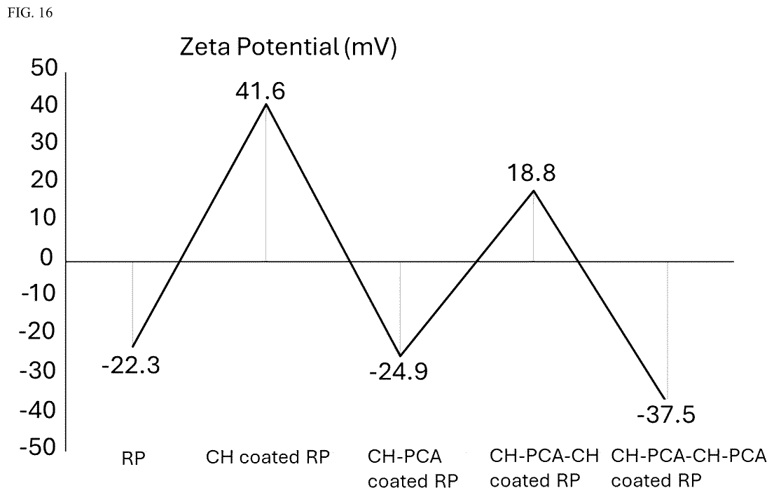

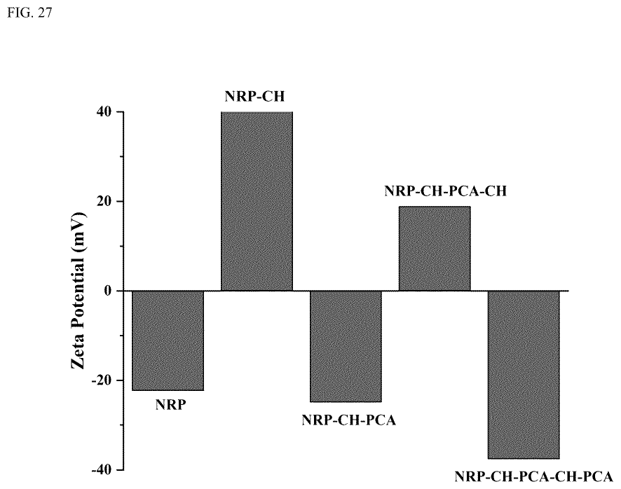

FIG. 16 and FIG. 27 show the differences in zeta potential of NRP, a particle having a NRP core and a first layer containing chitosan (RP-CH); a particle having a NRP core, a first layer containing CH, and a second layer containing PCA (CH-PCA coated RP); a particle having a NRP core, a first layer containing CH, a second layer PCA (RP-CH-, and a third layer containing CH (CH-PCA-CH coated RP); and a particle having a NRP core, a first layer containing CH, a second layer containing PCA, a third layer containing CH, and a fourth layer containing PCA (CH-PCA-CH-PCA coated RP). NRP typically exhibits a certain native surface charge, which depends on its composition and environmental conditions (pH, ionic strength, etc.). At neutral pH, the zeta potential of NRP is typically negative (−22.8 mV), as seen. Phosphate minerals maintain a negatively charged surface due to the deprotonation of hydroxyl and phosphate groups. After coating with chitosan, a cationic polymer, the zeta potential shifts toward a more positive value, indicating that the positively charged amine groups of chitosan dominate the surface charge of the particle. With an additional layer of PCA, an anionic polymer, the zeta potential shifts back toward negative values, reflecting the surface adsorption of negatively charged carboxyl groups from PCA. This shift in surface charge after each coating demonstrates the alternating layers of cationic and anionic polymers. The zeta potential values exhibit a consistent trend with each successive coating of CH and PCA, reinforcing the effectiveness of the layer-by-layer (LbL) assembly method. This progressive change in surface charge confirms the successful deposition of alternating cationic and anionic layers.

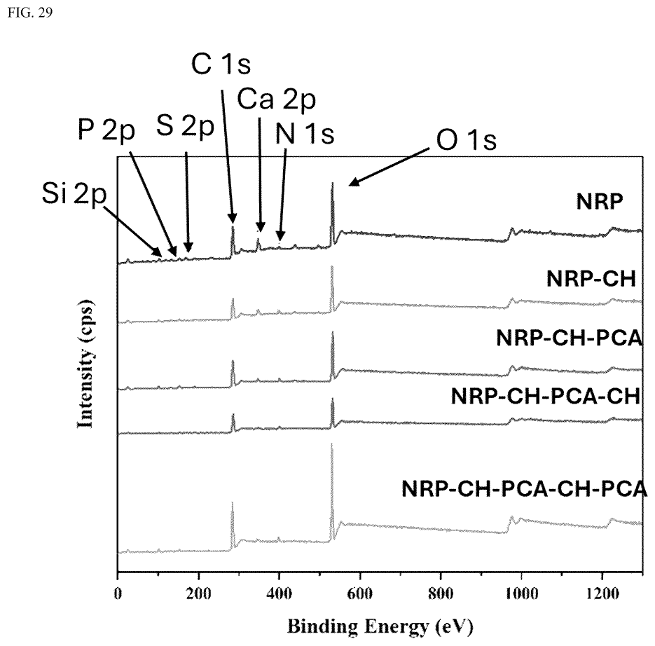

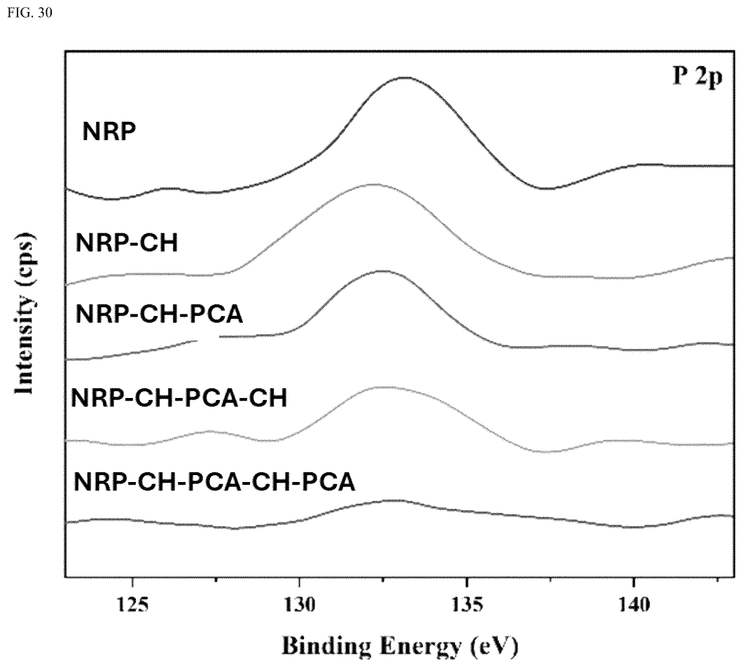

X-ray photoelectron spectroscopy (XPS) traces illustrate the difference in chemical composition of the surfaces of various particles including nano-rock phosphate alone (NRP); a NRP core coated with a first layer containing CH (NRP-CH); a NRP core coated with a first layer containing CH and a second layer containing PCA (NRP-CH-PCA); a NRP coated with a first layer containing CH, a second layer containing PCA, and a third layer containing CH (NRP-CH-PCA-CH); and a NRP core coated with a first layer containing CH, a second layer containing PCA, a third layer containing CH, and fourth layer containing PCA (NRP-CH-PCA-CH-PCA; FIG. 29 and FIG. 30). XPS is a powerful surface-sensitive technique used to study the first 3 to 10 nm of a particle surface. According to the XPS survey spectra (FIG. 29), Si 2p, phosphorus 2p, S 2p, Ca 2p, O 1s, and C 1s are observed in the uncoated NRP spectrum. The phosphorus 2p peak represents phosphorus in the NRP core. The Ca 2p likely originates from calcium present in the phosphate material. The Si 2p and S 2p peaks could be associated minerals in the natural rock phosphate apatite. The N Is peak intensity fluctuates according to the chitosan (CH) layers, while O 1s and C 1s intensities become more prominent due to the cumulative contribution of O and C from PCA. For thin coatings (a few nanometers thick), it is expected that the XPS signal from phosphorus (P 2p or the core) to be detectable but will be weaker.

FIG. 30 shows the high-resolution XPS phosphorus 2p spectra for the uncoated and coated NRPs. The phosphorus 2p peak typically occurs between 133 to 135 eV, reflecting phosphorus (P) in the P⁵⁺ oxidation state (common in phosphate groups) for NRP. This peak is relatively high in intensity and defined for uncoated NRP because phosphorus is fully exposed on the surface. Although CH can form hydrogen bonds or electrostatic interactions with the negatively charged phosphate groups on the NRP surface, these interactions are relatively weak and do not significantly alter the chemical state or electronic environment of the phosphorus atoms. As such, there is no observable shift in the XPS signal. This lack of a shift when coating with CH alone suggests that CH acts more as a physical barrier rather than chemically modifying the NRP surface. The overall intensity of the phosphorus 2p peak is reduced for NRP-CH particle because the chitosan coating blocks some of the phosphorus atoms from being detected by XPS. The intensity of the phosphorus signal after PCA coating is further reduced (for the NRP-CH-PCA particle), as the combined CH and PCA layers obscure more of the surface P. The overall decrease in P 2p peak intensity as the number of coatings increases is due to the attenuation of photoelectrons. Further, the survey spectra (FIG. 29) show progressively reduced intensities for the Ca 2p peak as well. This suggests that the Ca from the underlying rock phosphate is increasingly masked by the growing thickness of the alternating layers.

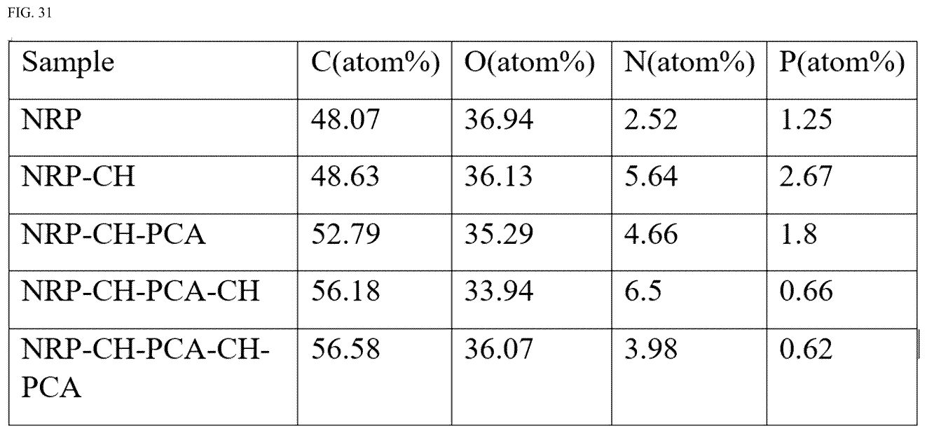

The XPS atomic percentages were also analyzed (FIG. 31) in order to understand how each coating layer modifies the surface composition of the particles. The carbon content generally increases with each successive coating, especially with the PCA layers, which are rich in carbon. Oxygen content decreases with the initial coatings but rises again with the final PCA layer, showing the influence of PCA's hyperbranched functional groups. Nitrogen levels rise with CH and decrease with PCA layers, reflecting the alternating nitrogenous CH and non-nitrogenous PCA coatings. Finally, phosphorus content also decreases with each successive coating, suggesting that the coatings increasingly mask the NRP core's phosphorus signal. The progressive intensity reduction without major binding energy shifts across additional coatings of CH and PCA further validates the effectiveness of the layer-by-layer (LbL) assembly approach applied in this study, as each coating layer progressively covers more of the underlying NRP core.

In one or more embodiments, a particle or a plurality of particles has a size or an average size of 50 nanometers (nm) or greater, 100 nm or greater, 200 nm or greater, 300 nm or greater, 400 nm or greater, 500 nm or greater, 600 nm or greater, 700 nm or greater, 800 nm or greater, 900 nm or greater, 1000 nm or greater, 1200 nm or greater, 1400 nm or greater, 1600 nm or greater, 1800 nm or greater, 2000 nm or greater, 2200 nm or greater, 2400 nm or greater, 2600 nm or greater, 2800 nm or greater, 3000 nm or greater, 3200 nm or greater, 3400 nm or greater, 3600 nm or greater, 3800 nm or greater, 4000 nm or greater, or 4500 nm or greater. In one or more embodiments, a particle or a plurality of particles has a size or an average size of 5000 nm or less, 4500 nm or less, 4000 nm or less, 3800 nm or less, 3600 nm or less, 3400 nm or less, 3200 nm or less, 3000 nm or less, 2800 nm or less, 2600 nm or less, 2400 nm or less, 2200 nm or less, 2000 nm or less, 1800 nm or less, 1600 nm or less, 1400 nm or less, 1200 nm or less, 1000 nm or less, 800 nm or less, 600 nm or less, 400 nm or less, 200 nm or less, or 100 nm or less.

In one or more embodiments, a particle or a plurality of particles has a size or an average size of 50 nm to 500 nm, such as 50 nm to 300 nm or 100 nm to 300 nm. In one or more embodiments, a particle or a plurality of particles has a size or an average size of 800 nm to 5000 nm such as 1000 nm to 3000 nm or 1000 nm to 2000 nm.

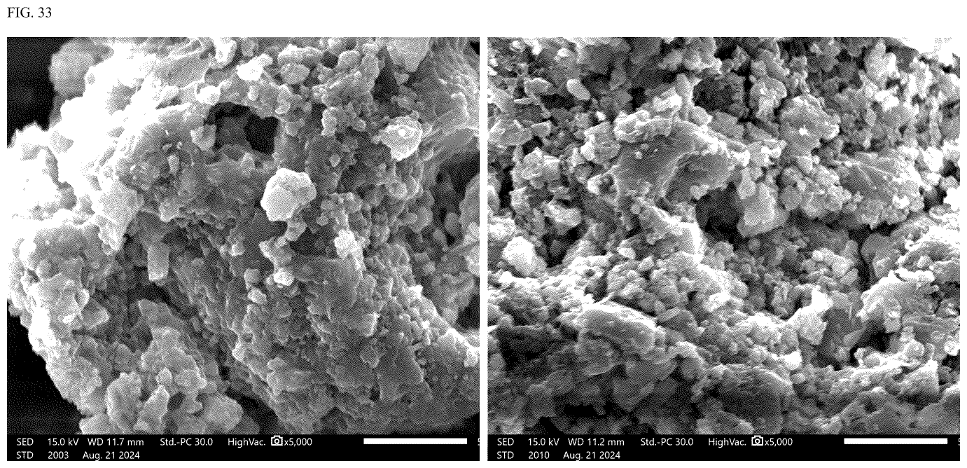

Scanning electron microscopy was used to analyze the surface of NRP particle cores and NRP coated particles (NRP-CH-PCA). The images revealed that the coating forms a relatively uniform and continuous layer around the NRP particles, demonstrating strong adherence and effective surface coverage (FIG. 32 where the left image is the uncoated NRP core and the right image is the coated NRP core). Some particle aggregation was observed which is a common occurrence with polymeric coatings. However, higher magnification (×5000) revealed nanoscopic pores or gaps on the surface of the coated fertilizers (FIG. 33), indicating areas where the coating may be thinner or less dense. These gaps or defects could potentially expose the underlying nano-phosphate core, suggesting partial or incomplete coverage in certain regions.

The particles can be tested for phosphorous leaching. For example, kinetic-release experiments may be conducted by placing a measured quantity of particles (e.g., 2 g) into a beaker containing distilled water (e.g., 200 mL). The content of the beaker can be mildly agitated at a constant rate of (e.g., 200 rpm) with the aid of a magnetic bar. Stirring can be maintained throughout the release experiment. At fixed time intervals, the conductivity of the aqueous solution can be measured, and the total amount of phosphorus released from the system as a function of time can be evaluated using a concentration conductivity calibration curve. Kinetic release can be tested as a function of layer number and the composition of abrasion-resistance layer (outermost layer). Different pH conditions may be tested as pH may play a role in phosphorus availability.

In the leaching study, it is thought that DAP will be released quickly to meet the plant phosphorus demand in the early stage of growth. The phosphorus in the core may be solubilized by the polyanion polymer (e.g., a polymer polymerized from at least citric acid) and the phosphorus will leach through the coating at a later stage and continue to leach out for a prolonged period.

FIG. 34 shows the cumulative concentration of phosphorus from a phosphorous leaching experiment conducted using nano-rock phosphate (NRP); a particle having a NRP core and a layer containing CH (NRP-CH); a particle having a NRP core, a first layer containing CH, and a second layer containing PCA (NRP-CH-PCA); a particle having a NRP core, a first layer containing CH, a second layer containing PCA, and a third layer containing CH (NRP-CH-PCA-CH); and a particle having a NRP core, a first layer containing CH, a second layer containing PCA, a third layer containing CH, and a fourth layer containing PCA (NRP-CH-PCA-CH-PCA). All the coated particle cores showed greater phosphorus leaching than rock phosphate with the only exception of nano-rock phosphate core and a layer of chitosan (NRP-CH). As NRP is highly insoluble very minimal phosphorus leaching was observed. Apatites typically supply phosphorus too slowly to optimize yields in annual crops. The application of the first layer of chitosan further slows down the release by forming an amorphous barrier and reducing the initial phosphorus bioavailability (the NRP-CH sample). This reduction in leaching may have been achieved due to the strong intercalation of phosphorus with chitosan. Applying subsequent coating of PCA atop the NRP-CH (the NRP-CH-PCA sample) leads to significantly greater phosphate availability, but the release is still relatively controlled. Chitosan, being hydrophilic, due to its amino and hydroxyl groups can swell and become porous when exposed to water. The swelling of the chitosan layer in the presence of water can create temporary pathways or pores that allow PCA molecules to diffuse through the layer and reach the underlying rock phosphate core. This can lead to H⁺ simultaneously associating with PO₄³⁻ of the insoluble NRP to form HPO₄²⁻ and H₂PO₄⁻ from PO₄³⁻ and replace the Ca²⁺ and Mg²⁺ ions from NRPs structure to release P. The inclusion of another layer of chitosan after PCA (the NRP-CH-PCA-CH sample) slows down the release again significantly compared to NRP-CH-PCA as this coating acts as a physical barrier. The same trend was seen after applying the final coating of PCA (the NRP-CH-PCA-CH-PCA sample) which showed a higher phosphorus release than NRP-CH-PCA-CH but lower than NRP-CH-PCA. Each additional layer of CH and PCA creates more barriers for phosphorus to cross, making it more difficult for phosphorus to diffuse out of the fertilizer particles.

The phosphorous release curves of FIG. 34 were fitted with zero-order kinetic equation, first-order kinetic equation, Higuchi model, Korsmeyer-Peppas model, Hixson-Crowell model Weibull model, and Baker-Lonsdale model to explore the release kinetics of the various particles. No model is universally applicable; each has its own limitations, prerequisites, or drawbacks. For instance, the Peppas model is only valid for up to 60% of the total release, yet they provide valuable insights into the release mechanism. To assess the goodness-of-fit and compare various models, the coefficients of determination (R²) and akaike's information criterion (AIC) have been utilized. The AIC aids in identifying the most parsimonious model from those applied to the experimental data. When comparing models, a lower AIC value indicates a well-fitting model that maintains simplicity.

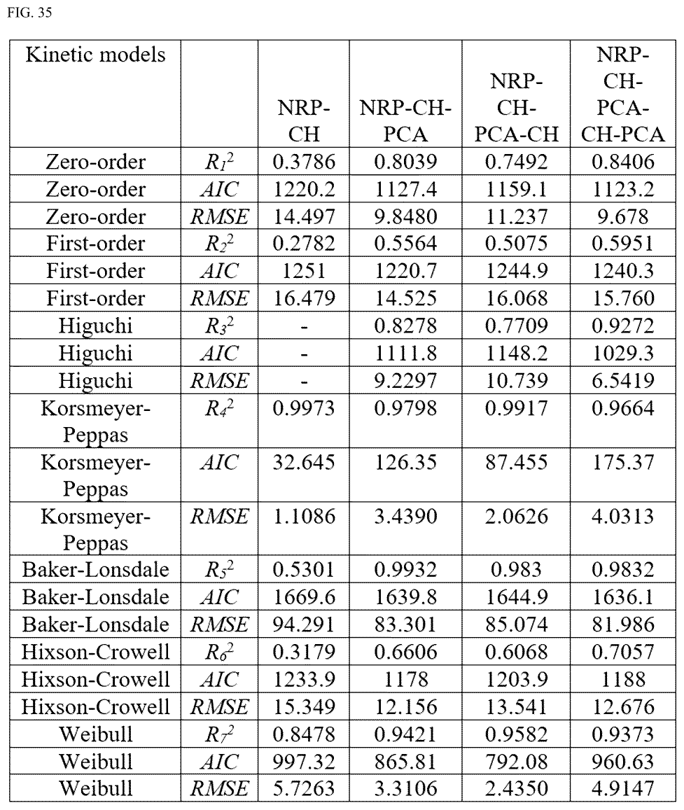

FIG. 35 presents the coefficients (R²), akaike information criterion (AIC), and Root Mean Square Error (RMSE) for all the examined models regarding phosphorus release of the particles tested in FIG. 35. The Korsmeyer-Peppas model outperforms others significantly for NRP-CH, with the highest R² and the lowest AIC and RMSE, suggesting a nearly perfect fit. Other models like zero-order, Hixson-Crowell, etc. show poor fits, reinforcing that simple concentration-dependent or surface area-dependent mechanisms are insufficient to describe the release. This effect is likely due to electrostatic and van der Waals interactions between the positively charged CH matrix and the nutrient ions, combined with polymer swelling, which significantly slows down diffusion compared to the NRP treatment. NRP-CH-PCA showed an excellent fit with both Baker-Lonsdale and Korsmeyer-Peppas models indicating that the nutrient release is governed at least by a combination of mechanisms. CH may slow diffusion through its semi-permeable, biodegradable nature, while PCA could influence the hydration and swelling properties, enhancing the combined transport effects. The dual fit suggests that the interaction between these layers creates a matrix where nutrients are released progressively, influenced by water penetration, polymer swelling, and erosion. The excellent fit with the Korsmeyer-Peppas model for NRP-CH-PCA-CH reiterates that the release mechanism involves both diffusion and polymer relaxation or erosion. The Weibull model also provides a good fit indicating that the release process involves multi-stage kinetics. Initially, the release might be influenced by a rapid diffusion phase, potentially captured by the Korsmeyer-Peppas model, followed by a slower, sustained release influenced by the matrix properties captured by the Weibull model. The Korsmeyer-Peppas model is the best fit for NRP-CH-PCA-CH-PCA again due to the complex interaction of diffusion and polymer relaxation/swelling processes that the model describes. Ending with a PCA layer also enhances diffusivity, possibly due to PCA's hydrophilic nature facilitating nutrient movement.

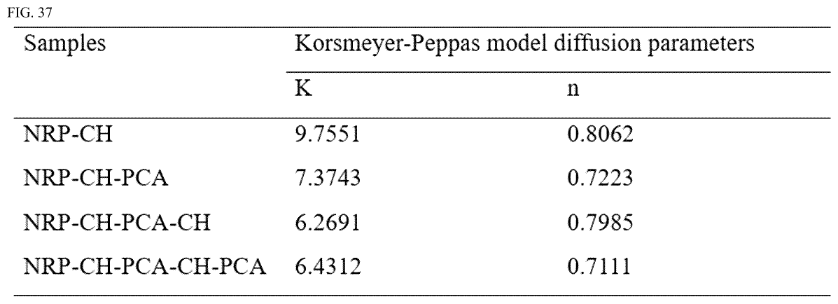

The Korsmeyer-Peppas model is the most appropriate for describing the release kinetics of the particles tested in FIG. 34. FIG. 37 recapitulates the data from fitting the curve of the phosphorus release using the Korsmeyer-Peppas model. NRP-CH has the highest K value at 9.7551, suggesting a relatively faster rate of release compared to the other samples. This could be due to the CH layer alone providing moderate diffusion control while allowing more rapid initial nutrient release. The addition of PCA likely modifies the matrix properties, making the release more controlled which can be seen from a lower K value. NRP-CH-PCA-CH shows a further decrease in K to 6.2691, suggesting that adding an extra layer of chitosan slows down the release rate. Although the K value for NRP-CH-PCA-CH-PCA is slightly higher than that of NRP-CH-PCA-CH, it still demonstrates that the alternating layers of PCA and CH can result in a balanced release profile with controlled initial rates.

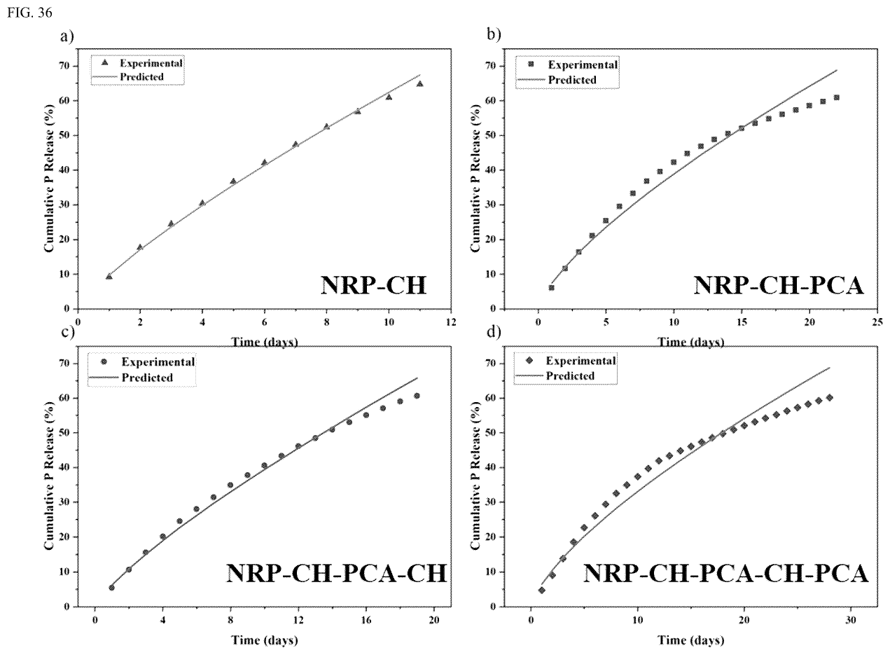

FIG. 36 and FIG. 37 present the fitted curves based on the Korsmeyer-Peppas model, along with the corresponding diffusion parameters. The values of n are between the range of 0.43 to 1, therefore phosphorus follows a diffusion release of the anomalous type, which means that its release from the coated NRPs takes place by non-Fickian diffusion. The n value is 0.8062 for NRP-CH indicating that the release is controlled by both diffusion and the relaxation of the CH polymer. This suggests that CH allows for some matrix swelling or relaxation alongside diffusion. NRP-CH-PCA has a lower n value of 0.7223, which still indicates anomalous transport but is closer to a diffusion-dominant profile. The inclusion of PCA, a hydrophilic layer, may facilitate faster water penetration, altering the diffusion characteristics. The additional CH layer on NRP-CH-PCA enhances the combination of diffusion and relaxation, as CH tends to swell and modulate the release. Alternating layers of PCA suggest a slight shift towards a more diffusion-dominant profile but still within the anomalous transport range. The presence of alternating CH and PCA layers leads to a complex release profile that balances initial nutrient release and prolonged availability.

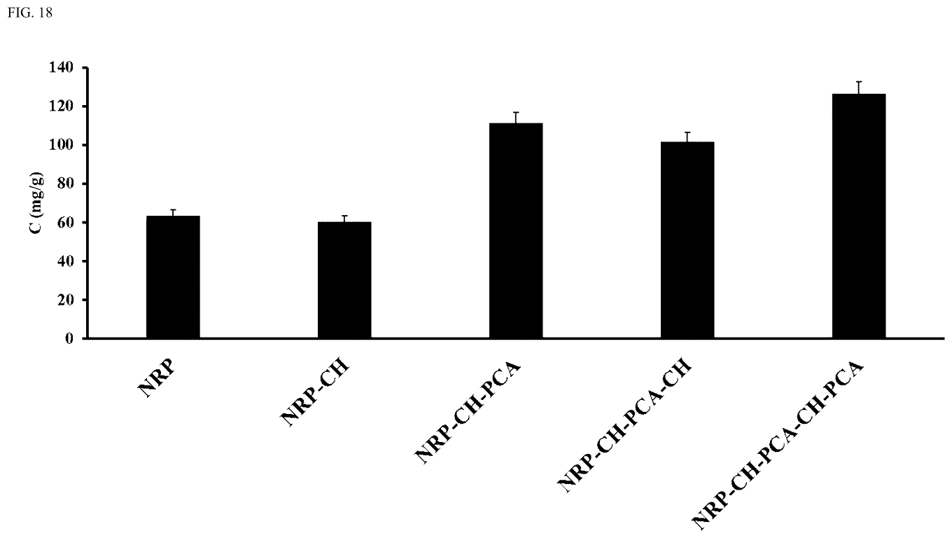

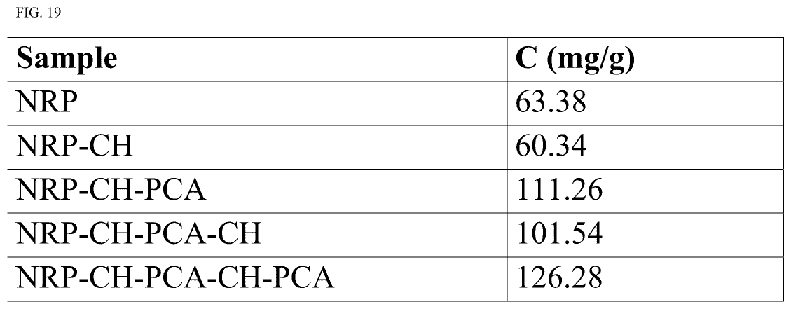

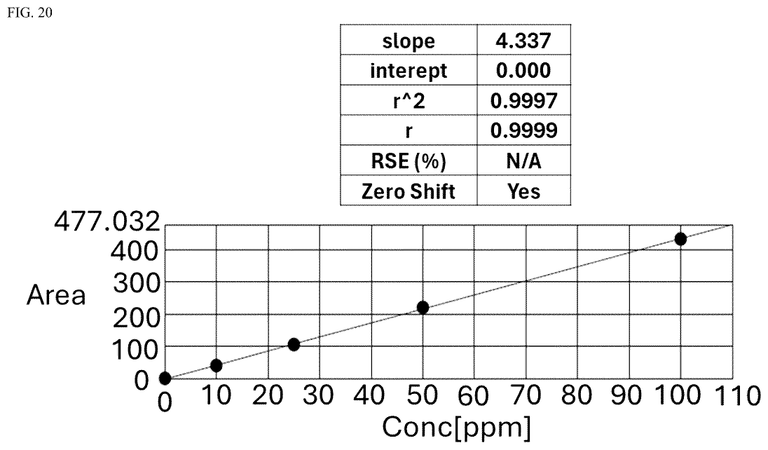

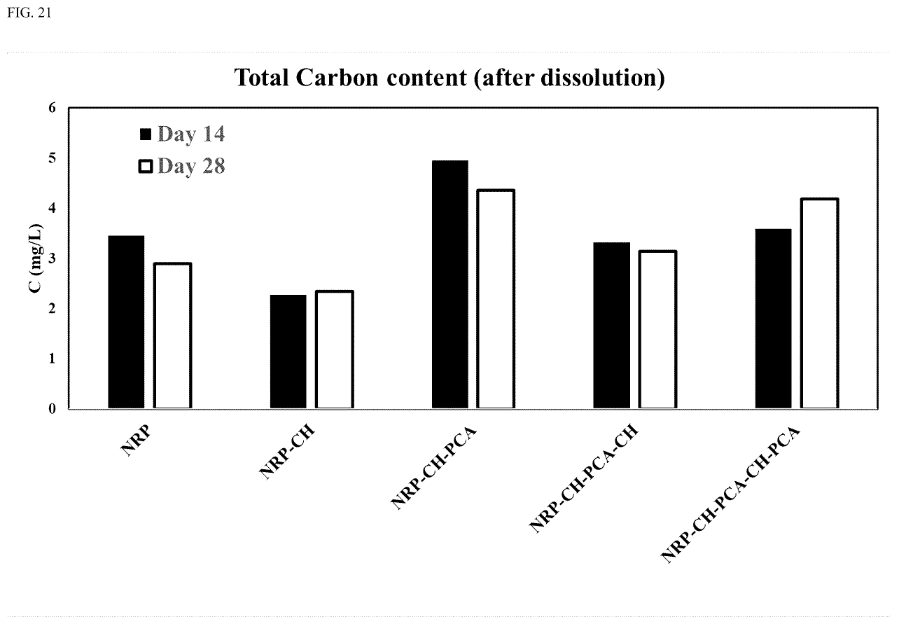

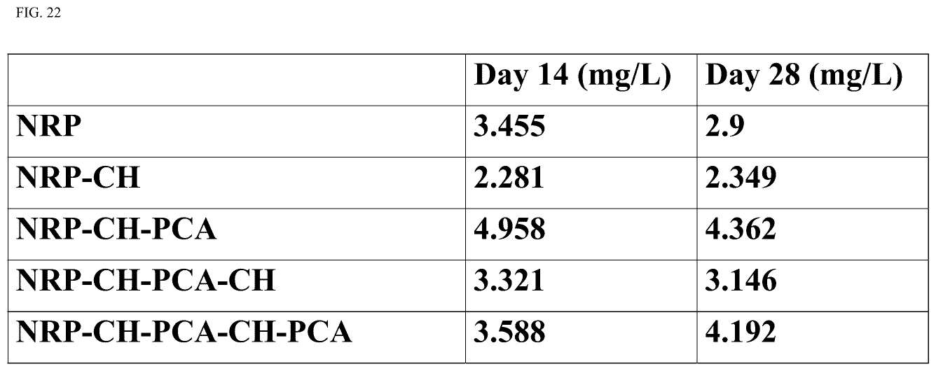

The total carbon content can be measured. Fertilizers that include carbon can improve soil quality. For example, fertilizers that include carbon can increase the carbon the nitrogen ratio and/or improve soil structure and/or stability. Improving soil structure and/or stability can improve soil aeration, water drainage, and water retention. FIG. 18 and FIG. 19 show the total carbon content for nano-rock phosphate (NRP), a NRP-CH particle, a NRP-CH-PCA particle, a NRP-CH-PCA-CH particle, and a NRP-CH-PCA-CH-PCA particle. FIG. 20, FIG. 21, and FIG. 22 show the total carbon content for the same particles after dissolution at two time points (day 14 and day 28). Higher carbon content could be seen for the substrates coated with PCA (NRP-CH-PCA, NRP-CH-PCA-CH and NRP-CH-PCA-CH-PCA) particles due to the presence of a number of —COOH functional groups and long carbon chains in the hyperbranched polymer, PCA.

In another aspect, the present disclosure describes compositions containing a plurality of the particles of the present disclosure. The composition may be a fertilizer composition. In one or more embodiments, the composition may include additional fertilizer components. For example, in one or more embodiments, the composition includes a plurality of particles of the present disclosure and a component that includes one or more additional plant nutrients.

A composition may include a plurality of particles of the present disclosure and a carrier. The formulations of the composition may include those suitable for treating the soil in which the target plant grows or the target plant directly. Types of formulations may include baits that include the plurality of particles, gels that include the plurality of particles, dusts that include the plurality of particles, water dispersible granules that are or contain the plurality of particles, dry powders containing the plurality of particles, soluble powders containing the plurality of particles, dry granules that are or contain the plurality of particles, pellets that are or contain the plurality of particles, emulsions that contain the plurality of particles, solutions that contain the plurality of particles, suspensions that contain the plurality of particles, impregnated products that contain the plurality of particles, fertilizer combinations that contain the plurality of particles, or aerosols that contain the plurality of particles.

The carrier may be any suitable carrier. In one or more embodiments, the carrier is a liquid, for example water. For example, the plurality of particles may be included in a water mixture or suspension. The carrier may be a solid. For example, the carrier may include soil. The composition may include other ingredients. For example, the composition may include additional fertilizer elements or components, plant nutrients, pesticides, compatibility agents, activating agents, buffers, anti-foaming agents, spray colorants, drift control agents, water conditioners, surfactants, or any combination thereof.

In another aspect, the present disclosure describes a method of using a particle and/or composition of the present disclosure. The method can be a method of administering or delivering particles of the present disclosure and/or a composition of the present disclosure to a plant. subject. The target plant may be any plant to which the particles of the present disclosure are to be administered.

In one or more embodiments, the method includes delivering particles or composition including the same to a target plant. For example, the method may include delivering particles or compositions including the same to a target plant or a media in contact with the target plant. An example media in contact with a target plant can be the soil in which the target plant or seed of the target plant is located. The method may include delivering particles or compositions including the same to a target plant, target plant seeds, a media in contact with the target plant and/or seed, or any combination thereof. Administering the particles or compositions containing the same may include contacting a target plant, a target plant seed, or media in contact with the target plant and/or target seed, or any combination thereof with the particles or composition containing the particles.

The type of delivery or administration may depend at least in part on the formulation of the composition that includes the particles. For example, in one or more embodiments, a composition including the particles that is a liquid or a suspension can be delivered by spraying or misting the target plant, target plant seeds, the media in contact with the target plant and/or target plant seeds, or any combination thereof. In other embodiments, a compostions including the particles that is a solid can be placed in contact with the target plant, target plant seeds, the media in contact with the target plant and/or target plant seeds, or any combination thereof.

Exemplary plants that may be a target plant include, but are not limited to, a field crop (e.g., tobacco, soybeans, corn, cotton, fruits, rice, wheat, vegetables, legumes, nuts, potatoes, watermelon etc.), a tree (e.g., poplar, rubber tree, etc.), or turfgrass (e.g. creeping bentgrass).

In another aspect, the present disclosure describes a method of delivering phosphorous, nitrogen, or both to target plant. The method includes delivering the particles or composition containing the same to a target plant, target plant seeds, a media in contact with the target plant and/or target plant seeds, or any combination thereof. The method may further include allowing the particles to release phosphorous, nitrogen, or both. In one or more embodiments, the method may further include stimulating the release of phosphorous, nitrogen, or both from the particles. For example, the method may include contacting the particles with an aqueous solution or water. The water may facilitate dissolution of the particles to release phosphorous, nitrogen, or both.

### EXAMPLES

The present disclosure is illustrated by the following examples. It is to be understood that the particular examples, materials, amounts, and procedures are to be interpreted broadly in accordance with the scope and spirit of the disclosure as set forth herein.

### Example 1 (Prophetic): Evaluation of Mechanical Properties of Films Made of Layer Materials

For some particles of the present disclosure thin films of chitosan (CH) and/or poly(citric acid-co-glycerol) (PCA) may be deposited on bulk rock phosphate (RP) or bulk hydroxyapatite (HAP) cores. The mechanical, thermomechanical and moisture transfer properties across the layers can be characterized.

To study these parameters, CH/PCA films (containing an equal weight ratio of the components used to coat granules) can be created in a Teflon coated petri dish. Aqueous dispersion of CH, PCA and glycerol will be dissolved for 30 min at different concentration in warm water (70° C.) under magnetic stirring (150 rpm). Film casts can be prepared by individually pouring 20 mL of the hot resulting dispersions into a 100 mm Teflon-coated circular trays. Films can be dried in a fan oven at 40 degrees Celsius for 24 h. Upon drying, the resultant films can be peeled off and tested.

Mechanical properties of the PCA CH films: Free films can be evaluated for the mechanical properties for tensile test and can be performed on Instron Instrument, based on ASTM D-412 test. The measurements can be made at a gauge length of 50 mm, cross head speed (CHS) of 25 mm/min at 50% RH and 25° C. The tensile strength, percent elongation and modulus of elasticity can be computed for at least three repetitions.

Investigation of thermomechanical properties of PCA CH film: Thermogravimetric analysis (TGA) test of the films can be carried out. The temperature can be scanned from 20 to 500° C. at a heating rate of 10° C./min under a nitrogen gas flow. The thermal decomposition (or degradation) profile can be analyzed using TA Universal Analysis 2000 software (TA Instruments, Hertfordshire, UK). Differential scanning analysis (DSC) can be carried out using TA analysis 2000 (TA Instruments, Hertfordshire, UK). Samples can be heated to 100° C. for 5 min to exclude the effect of humidity then cooled to −20 degrees Celsius, followed by a heat-scan from −20 to 180 degrees Celsius Analysis can be carried out under a purge of nitrogen (50 mL/min) at a heating rate of 10 degrees Celsius/min.

Water vapor transmission rate (WVTR) studies: Dry films composed of PCA/CH can be cut into appropriate dimensions and can be mounted on a permeation cell containing saturated salt solution (excess salt) of potassium acetate, potassium carbonate, sodium chloride and potassium nitrate to provide relative humidity (RH) conditions of 23, 43, 75 and 93%. The charged cells can be weighed and placed in pre-equilibrated desiccators maintained at 0% RH and reweighed at the end of 24 h. The amount of water transmitted (W) through the film can be given by the weight loss of the assembled cell. The WVTR can be computed using Utsumi's equation, i.e., Q=WL/S, where W=gram of water transmitted/24 h, L=film thickness (cm), S=surface area (cm2), Q=water vapor transmission (g cm/cm2/24 h).

### Example 2 (Prophetic): Testing of the Particles as Fertilizers

Testing for Phytotoxicity: The particles can be evaluated to understand their effects on plants. Some particles can be deposited on the plant itself when the fertilizer is broadcast in the field. To evaluate safety of the film material, phytotoxicity (plant tissue damage) study can be done under greenhouse growth conditions (in pots). Soybean (Glycine max) plants can be grown in the greenhouse and sprayed with only the coating material mixture (not the particles). Application rate can be determined based on Tidal Vision's Tidal Grow 3% CH recommended application rate (130-300 mL/acre). Controls can be run where an equivalent amount of distilled water will be sprayed. Plants can be monitored for potential tissue damage for one week. Phytotoxicity ratings can be: (+) minimal (showing a few scattered brown spots), (++) moderate (multiple brown spots on multiple leaves), (+++) severe (large brown spots on most leaves) and (−) non-phytotoxic (no brown spots).

Testing for Seed Germination and Growth: To evaluate safety of the film material, seed germination study can be also done in lab conditions.

Seed preparation: Soybean seeds can be purchased from a nursery. In brief, seeds can be first soaked in DI water for 30 minutes to soften the seed coat. Following that, the seeds can be rinsed with separate solutions of 70% ethanol and 1% sodium hypochlorite, and then the seeds can be washed with copious amount of DI water to rinse off residual ethanol and hypochlorite. Seed can be then soaked in a 50 mL of treatment (e.g., PCA, CH, nanoBC, nanoS, PCA-CH, PCA-CH-nanoBC-nanoS, PCA-CH-nanoBC, PCA-CH-nanoS) for 24 h.

Germination: After seeds are soaked in the treatment solution for 24 h, seeds can be placed on petri dishes with a filter paper. Each petri dish can contain 10 seeds and the experiment can be done in triplicates. A total of 5 mL of corresponding treatment can be added to each petri dish with seeds and filter paper. The petri dish can be then wrapped in the paraffin film to eliminate moisture loss. The germination rate can be recorded after over 10 days and considered successful if the length of the coleoptiles was longer than 2 mm. A successful germination can be determined as percent seeds germinated compared the total seeds used (Germination, %=#of seeds germinated/Total #of seeds in the petri dish×100%).

Shoot and root length: The length of the shoot and the root of the plants can be measured using a standard ruler. Statistical Analysis: One-way Anova test can be used to see if there is a statistically significant difference among the treatments. Tukey post-hoc analysis will be used to know where these differences are.

### Example 3 (Prophetic): Evaluation of Particles in Soils

This Example will use different approaches to assess the impact of a range of particle functionality. In general, the particles of the present disclosure are aimed at improving phosphorus-nutrient use efficiency by promoting phosphorus uptake by plants, reducing phosphorus loss via runoff and leaching, modulating phosphorus fixation in soil, reducing undesirable interactions of phosphorus with essential micronutrients, enhancing plant productivity and produce nutritional quality, or any combination thereof. These outcomes are expected to occur at significantly higher degrees compared to conventional phosphorus fertilizers and pristine rock phosphate. Accordingly, the following technical approaches can be pursued to realize these objectives.

Determination of phosphorus loss in soil from particles: Like their conventional counterparts, nanoscale nutrients are known to be influenced by soil properties such as pH. Therefore, nano-enabled phosphorus-fertilizer products (particles) can be characterized in soil for their potential to inhibit phosphorus loss via run off and leaching. To this end, three types of soils can be used, an acidic (pH≤5.5), a neutral (pH≈7), and an alkaline (pH≈8) soil. For the runoff loss studies, the products at a known phosphorus concentration compatible with real-life phosphorus application rate (≤100 mg/kg) can be surface applied on the soils loaded into a rectangular container tilted to between 20 and 15 degrees to generate slope for run off event. Water can be applied from the higher end of the container using a strainer to simulate rainfall. The run-offs from this process can be collected from the lower end of the container in a receptacle and measured for phosphorus content using ICP-OES.

Phosphorus leaching from particles when applied to soil: For leaching loss evaluation, the particles can be similarly incubated in the soils under a watering regime that leaves the soil moist, but not saturated. Leachates from soil can be collected daily for 5 days, to understand the phosphorus leaching dynamics of the products. Leachates would be analyzed using ICP OES. Simultaneously, the levels of other elements known to interact with phosphorus in soil, such as Zn, Fe and Ca, can also be assessed analytically, to understand the effect of phosphorus on their bioavailability. In both the run-off and leaching loss studies, several control and experimental treatments can be evaluated. Controls can include of soils with no added phosphorus and soils incubated with a conventional phosphorus-fertilizer, namely, commercial diammonium phosphate (DAP) granules, rock phosphate (RP), and hydroxyapatite (HAP). It is thought that nano-enabling RP and HAP will reduce run off and leaching losses, for example, by regulating the solubility of the phosphorus-fertilizer, relative to the conventional phosphorus controls.

Evaluation of particles in plants (greenhouse-based studies): The effect of the nano-enabled fertilizer products (particles) on crop productivity (vegetative and reproductive) can be assessed in full life cycle studies involving a monocot and a dicot crop. To this end, corn and soybean can be used. These growth studies can be conducted at a greenhouse facility using the same soil types previously used for the phosphorus loss evaluation studies. Soils with different pH can be tested. The soils (8 kg) can be loaded into pots in 4 replicates and amended with the different phosphorus products and with nitrogen and potassium, per rate recommendations for each crop. However, the nitrogen rate will be matched with that contained in the DAP control treatments, to eliminate nitrogen supply differentials. Replicated treatments can be established using the nano-enabled products developed with RP and HAP, in addition to conventional granular DAP, RP and HAP, for control comparisons. In the greenhouse studies, additional controls of the building block materials, namely, poly(citric acid), chitosan, nanoS, and biochar, at the rates used in formulating the different products can be evaluated as quality control. These studies can be conducted for each crop; plants can be maintained under regular greenhouse growth conditions and watered as needed. During growth, data on seed germination rates, leaf chlorophyll content (SPAD), days to emergence of flag leaves and grain heads (for corn) and flowers (for soybean), life cycle shoot biomass, and grain yields can be recorded.

Evaluation of particles in the field: Subsequent to the greenhouse studies, the particles can be evaluated in crops under field conditions for effect on grain yield and yield components. This can involve using the products at 50% and 100% of the recommended phosphorous application rates, compared with the conventional phosphorous fertilizer (DAP), RP, and HAP, each of which would be applied at the 100% rate. The soil to be used can be Chesire fine sandy loam and would be fully characterized for chemical and physical properties.

Determination of nutrient accumulation in crops from particles: At harvest, greenhouse and field plants can be separated into root, shoot, and grains and processed for dry matter content. The tissues can be used for subsequent elemental analysis. To that effect, plant uptake of phosphorous, as well as of Zn, Fe, and Ca, can be assessed by ICP OES using the processed plant tissues from both greenhouse and field (only grains) studies. Simultaneously, soil fractions from the different treatments in the greenhouse studies can be extracted using appropriate methods for both plant bioavailable non-bioavailable (acid-releasable) phosphorous fractions, and analyzed by ICP OES, as per plant tissues. Examples of things that can be measured include the total uptake of phosphorous in soil and its translocation to the shoot and to the grain; the residual levels of total phosphorous in soil after plant harvest; the mass balance of phosphorous in the plant-soil system; and the potential uptake-inhibiting interaction of phosphorous from the products with plant-essential trace metals of interest to human health, namely Zn, Fe and Ca.

Effect of particles on soil microbiology: Phosphorous solubility in soil is thought to be driven by a range of microbial enzyme activity. Accordingly, some of these microbial processes can be investigated as a function of phosphorous-product type. To this end, rhizosphere soils from planted soils can be collected and prepared by water-buffer extraction, and native bacterial colony forming units (CFU) counts can be made. Soil enzyme activities can be evaluated based on published procedures for activities involved in phosphorous metabolism, including alkaline and acid phosphatases, phytase, dehydrogenase, and beta-glucosidase. Total soil carbon can be measured using a combustion analyzer.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A particle comprising:
a core comprising a fertilizer element;
a first layer comprising a polycation polymer, the first layer disposed on at least a portion of the core; and
a second layer comprising a polyanion polymer, the second layer disposed on at least a portion of the first layer.

2. The particle of claim 1, wherein the fertilizer element is phosphorous, and the core comprises 5 atom-% or greater phosphorous.

3. The particle of claim 1, wherein the fertilizer element is phosphorus, and the core comprises fluorapatite (Ca₅(PO₄)₃F), hydroxyapatite (Ca₅(PO₄)₃OH or Ca₁₀(PO₄)₆(OH), phosphorus pentoxide, or any combination thereof.

4. The particle of claim 3, wherein the core comprises SiO₂.

5. The particle of claim 3, wherein the fertilizer element is phosphorus, and the core comprises rock phosphate.

6. The particle of claim 1, wherein the fertilizer element is phosphorus and the core comprises hydroxyapatite.

7. The particle of claim 1, wherein the core has a size of 50 nm to 500 nm.

8. The particle of claim 1, wherein the polyanion polymer comprises a polysaccharide polymer.

9. The particle of claim 1, wherein the polycation polymer comprises chitosan, D-glucosamine, chitin, or any combination thereof.

10. The particle of claim 1, wherein the polyanion polymer is polymerized from citric acid or citrate and glycerol.

11. The particle of claim 1, wherein the polyanion polymer is a branched polyanion polymer.

12. The particle of claim 1, wherein the particle further comprises one or more additional layers comprising a polycation polymer or a polyanion polymer.

13. The particle of claim 1, wherein the particle further comprises outermost layer comprising biochar, nano-biochar, elemental sulfur, nano-sulfur, or any combination thereof.

14. The particle of claim 1, wherein the particle further comprises an outermost layer comprising biochar or nano-biochar impregnated with diammonium phosphate (DAP), monoammonium phosphate (MAP), or both.

15. A composition comprising:
a plurality of the particles, each particle of the plurality of particles comprising:
a core comprising a fertilizer element;
a first layer comprising a polycation polymer, the first layer disposed on at least a portion of the core; and
a second layer comprising a polyanion polymer the second layer disposed on at least a portion of the first layer; and
a carrier.

16. The composition of claim 15, wherein the carrier is an aqueous liquid or a solid.

17. A method of delivering the composition of claim 15 to a target plant, the method comprising contacting the target plant, target plant seed, media in contact with the target plant, media in contact with target plant seeds, or any combination thereof with the composition of claim 15.

18. The method of claim 17 wherein the media in contact with the target plant, the media in contact with target seeds, or both, comprises soil in which the target plant or target seeds is located.

19. A method for delivering phosphorus to a target plant, the method comprising delivering a plurality of particles to the target plant, target plant seeds, media in contact with the target plant, media in contact with target plant seeds, or any combination thereof, wherein each particle comprises:
a core comprising a fertilizer element;
a first layer comprising a polycation polymer, the first layer disposed on at least a portion of the core; and
a second layer comprising a polyanion polymer polymerized, and the second layer disposed on at least a portion of the first layer.

20. The method of claim 19, wherein the method further comprises allowing the plurality of particles to release phosphorus.
